(19) United States
(12) Patent Application Publication
(10) Pub. No.: US 2026/0340156 A1
(43) Pub. Date: Oct. 29, 2026

(54) SERVICE PROVIDING APPARATUS THAT PROVIDES SPECIFIC SERVICE TO USER AND COMPUTER-READABLE NON-TRANSITORY RECORDING MEDIUM STORING SERVICE PROVIDING PROGRAM

(71) Applicant: KYOCERA Document Solutions Inc., Osaka (JP)

(72) Inventor: Tatsuya HIWATARI, Osaka (JP)

(73) Assignee: KYOCERA Document Solutions Inc., Osaka (JP)

(21) Appl. No.: 19/659,237

(22) Filed: Apr. 27, 2026

(30) Foreign Application Priority Data
Apr. 28, 2025 (JP) 2025-074965

(51) Int. Cl. G06F 21/60

(52) U.S. Cl. CPC G06F 21/604

(57) ABSTRACT

A service providing apparatus that provides a specific service to a user is configured to, when the service providing apparatus manages a local user on the basis of authentication by the service providing apparatus itself, when an import of an external user is accepted from a user management system that is connected to the service providing apparatus and manages a user as an external user independently, and when account information indicating the external user to be imported is received from the user management system during the import, in a case where an external user that is managed in the service providing apparatus is deleted in the account information, change the deleted external user to a local user and manage the changed local user in the service providing apparatus.

### INCORPORATION BY REFERENCE

This application claims priority to Japanese Patent Application No. 2025-074965 filed on Apr. 28, 2025, the entire contents of which are incorporated by reference herein.

### BACKGROUND

The present disclosure relates to a service providing apparatus and a computer-readable non-transitory recording medium storing a service providing program.

A technique that deletes a user while achieving synchronization among a plurality of systems is known.

### SUMMARY

As one aspect of the present disclosure, a technique improved over the above-described technique is proposed.

A service providing apparatus according to one aspect of the present disclosure is a service providing apparatus that provides a specific service to a user. The service providing apparatus includes a storage device and a control device. The storage device is configured to store a service providing program. The control device includes a processor and, upon execution of the service providing program by the processor, functions as a service provider. The service provider is configured to perform a process in cases including: (i) managing a local user on the basis of authentication by the service providing apparatus itself; (ii) accepting an import of an external user from a user management system that is connected to the service providing apparatus and independently manages a user as an external user; and (iii) receiving account information indicating the external user to be imported from the user management system during the import, wherein, when an external user that is managed in the service providing apparatus is indicated as deleted in the account information, the service provider changes the deleted external user to a local user and manages the changed local user in the service providing apparatus.

A computer-readable non-transitory recording medium according to one aspect of the present disclosure stores a service providing program. The service providing program causes a computer to operate a service provider configured to perform a process in cases including: (i) managing a local user on the basis of authentication by the service providing apparatus itself; (ii) accepting an import of an external user from a user management system that is connected to the service providing apparatus and independently manages a user as an external user; and (iii) receiving account information indicating the external user to be imported from the user management system during the import, wherein, when an external user that is managed in the service providing apparatus is indicated as deleted in the account information, the service provider changes the deleted external user to a local user and manages the changed local user in the service providing apparatus.

### BRIEF DESCRIPTION OF THE DRAWINGS

FIG. 1 is a block diagram of an example of a system according to a first embodiment of the present disclosure.

FIG. 2 is a block diagram of an example of a service providing apparatus shown in FIG. 1 in the case of being configured with one computer.

FIG. 3 is a diagram showing an example of organization management information shown in FIG. 2.

FIG. 4 is a diagram showing an example of group management information shown in FIG. 2.

FIG. 5 is a diagram showing an example of user management information shown in FIG. 2.

FIG. 6 is a diagram showing an example of deletion suspended user information shown in FIG. 2.

FIG. 7 is a block diagram of an example of a user management system shown in FIG. 1 in the case of being configured with one computer.

FIG. 8 is a diagram showing an example of organization management information shown in FIG. 7.

FIG. 9 is a diagram showing an example of user management information shown in FIG. 7.

FIG. 10 is a block diagram of an example of a manager terminal shown in FIG. 1.

FIG. 11 is a block diagram of an example of a user terminal shown in FIG. 1.

FIG. 12 is a block diagram of an example of an image forming apparatus shown in FIG. 1 in the case of being configured with an MFP.

FIG. 13 is a block diagram of an example of an IT operator terminal shown in FIG. 1.

FIG. 14 is a sequence diagram of an operation of the system shown in FIG. 1 in a case where an IT operator logs into the user management system via a web browser of the IT operator terminal.

FIG. 15 is a sequence diagram of an operation of the system shown in FIG. 1 in a case where a manager logs into the service providing apparatus via a web browser of the manager terminal.

FIG. 16 is an editing screen of information of a user specific to the service providing apparatus shown in FIG. 2.

FIG. 17 is an editing screen of information of a user imported from the user management system shown in FIG. 7.

FIG. 18 is a flowchart of an operation of the service providing apparatus shown in FIG. 2 in a case where synchronization of a user of the user management system is instructed.

FIG. 19 is a flowchart of an operation of the service providing apparatus shown in FIG. 2 in the case of automatically executing synchronization of a user of the user management system.

FIG. 20 is a flowchart of an operation of the service providing apparatus shown in FIG. 2 in the case of deleting information of a user included in the deletion suspended user information from the user management information.

FIG. 21 is a sequence diagram of an operation of the system shown in FIG. 1 in a case where a user logs into the service providing apparatus via the image forming apparatus.

FIG. 22 is a flowchart of an operation of the system shown in FIG. 1 in a case where a user who has received a password setting mail at the user terminal sets a password.

FIG. 23 is a block diagram of an example of a service providing apparatus according to a second embodiment of the present disclosure in the case of being configured with one computer.

FIG. 24 is a diagram showing an example of job management information shown in FIG. 23.

FIG. 25 is a flowchart of an operation of the service providing apparatus shown in FIG. 23 in the case of storing a print job in a storage device.

FIG. 26 is a flowchart of an operation of the service providing apparatus shown in FIG. 23 in a case where synchronization of a user of the user management system is instructed.

FIG. 27 is a flowchart of an operation of the service providing apparatus shown in FIG. 23 in the case of automatically executing synchronization of a user of the user management system.

FIG. 28 is a flowchart of an operation of the service providing apparatus shown in FIG. 23 in the case of deleting a print job from the storage device.

FIG. 29 is a flowchart of an operation of the service providing apparatus shown in FIG. 23 in the case of deleting information of a user included in the deletion suspended user information from the user management information.

FIG. 30 is a block diagram of an example of a service providing apparatus according to a third embodiment of the present disclosure in the case of being configured with one computer.

FIG. 31 is a diagram showing an example of user management information shown in FIG. 30.

FIG. 32 is a flowchart of an operation of the service providing apparatus shown in FIG. 30 in a case where synchronization of a user of the user management system is instructed.

FIG. 33 is a flowchart of an operation of the service providing apparatus shown in FIG. 30 in the case of automatically executing synchronization of a user of the user management system.

FIG. 34 is a block diagram of an example of a service providing apparatus according to a fourth embodiment of the present disclosure in the case of being configured with one computer.

FIG. 35 is a flowchart of an operation of the service providing apparatus shown in FIG. 34 in the case of automatically executing synchronization of a user of the user management system.

FIG. 36 is a flowchart of an operation of the service providing apparatus shown in FIG. 34 in a case where synchronization of a user of the user management system is instructed.

### DETAILED DESCRIPTION

Hereinafter, embodiments of a service providing apparatus, a service providing program, and a computer-readable non-transitory recording medium storing a service providing program according to the present disclosure will be described with reference to the drawings.

### First Embodiment

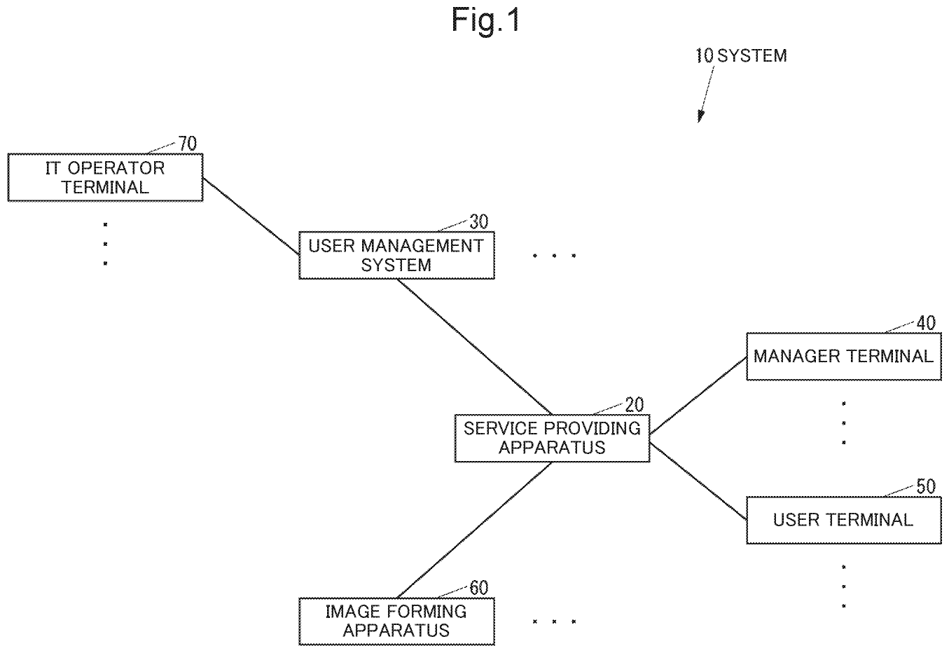

First, a configuration of a system according to a first embodiment of the present disclosure will be described. FIG. 1 is a block diagram of an example of a system 10 according to the present embodiment.

As shown in FIG. 1, the system 10 includes a service providing apparatus 20 that provides a specific service to a user. The service providing apparatus 20 may be configured with one computer such as a personal computer (PC) or may be configured with a plurality of computers. The service providing apparatus 20 may be configured on a cloud. Examples of a service that is provided by the service providing apparatus 20 include a service that transmits print data to be printed in an image forming apparatus to the image forming apparatus according to a request from the image forming apparatus and a service that receives image data read by a scanner of an image forming apparatus from the image forming apparatus and manages the image data.

The system 10 includes a user management system 30 that is disposed outside the service providing apparatus 20 and manages a user. For example, the system 10 may include a plurality of user management systems 30. The user management system 30 may be configured with one computer such as a PC or may be configured with a plurality of computers. The user management system 30 may be configured on a cloud. The user management system 30 is, for example, Microsoft Entra ID or Google Workspace.

The system 10 includes a manager terminal that is used by a manager among the users of the service providing apparatus 20. For example, the system 10 may include a plurality of manager terminals 40. The manager terminal may be configured with, for example, a computer such as a PC or a tablet.

The system 10 is connected to a user terminal that is used by a user of the service providing apparatus 20. For example, the system 10 is connected to a plurality of user terminals 50. The user terminal may be configured with, for example, a computer such as a PC or a tablet.

The system 10 is connected to an image forming apparatus that uses a service to be provided by the service providing apparatus 20. For example, the system 10 is connected to a plurality of image forming apparatuses 60. The image forming apparatus may be configured with, for example, a multifunction peripheral (MFP).

The system 10 is connected to an IT operator terminal that is used by a person (hereinafter, referred to as an “IT operator”) who executes various operations on the user management system 30. For example, the system 10 is connected to a plurality of IT operator terminals 70. The IT operator terminal may be configured with, for example, a computer such as a PC or a tablet. The IT operator may also be served by the manager. In a case where the IT operator is also served by the manager, the IT operator terminal may be the manager terminal.

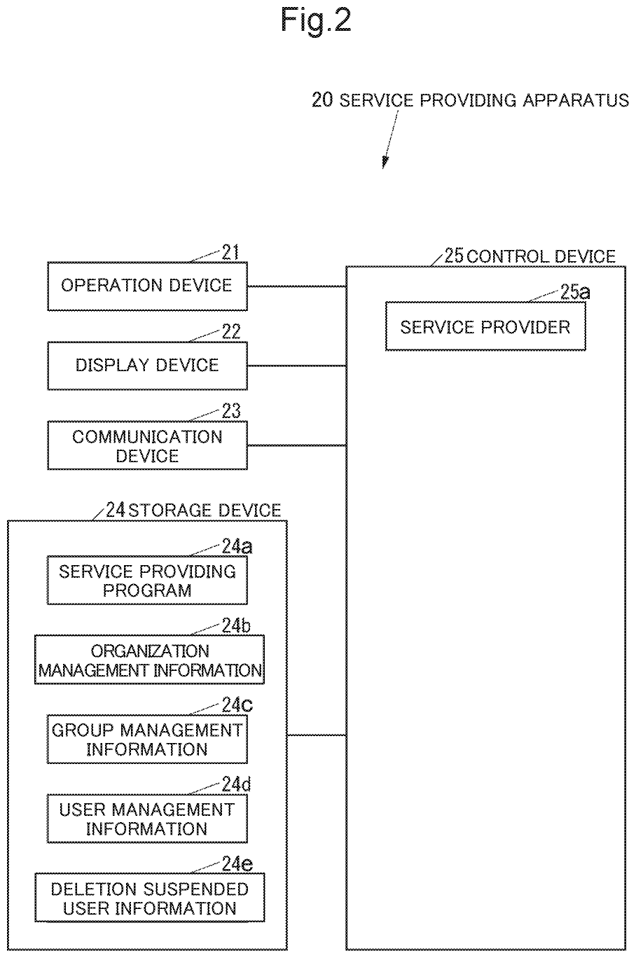

FIG. 2 is a block diagram of an example of the service providing apparatus 20 in the case of being configured with one computer.

As shown in FIG. 2, the service providing apparatus 20 includes an operation device 21 that is, for example, an operation device to which various operations are input, such as a keyboard and a mouse, a display device 22 that is, for example, a display device configured to display various kinds of information such as a liquid crystal display (LCD), a communication device 23 that is, for example, a communication device configured to perform communication with an external apparatus via a network such as a local area network (LAN) or the Internet or directly in a wired or wireless manner not via a network, a storage device 24 that is, for example, a nonvolatile storage device configured to store various kinds of information such as a semiconductor memory or a hard disk drive (HDD), and a control device 25 that controls the entire service providing apparatus 20.

The storage device 24 stores a service providing program 24a for providing a specific service to a user. The service providing program 24a may be installed on the storage device 24 in a manufacturing step of the service providing apparatus 20, may be additionally installed on the storage device 24 from an external storage medium such as a universal serial bus (USB) memory, or may be additionally installed on the storage device 24 from a network, for example.

The storage device 24 stores organization management information 24b that manages an organization to which a user of the service providing apparatus 20 belongs.

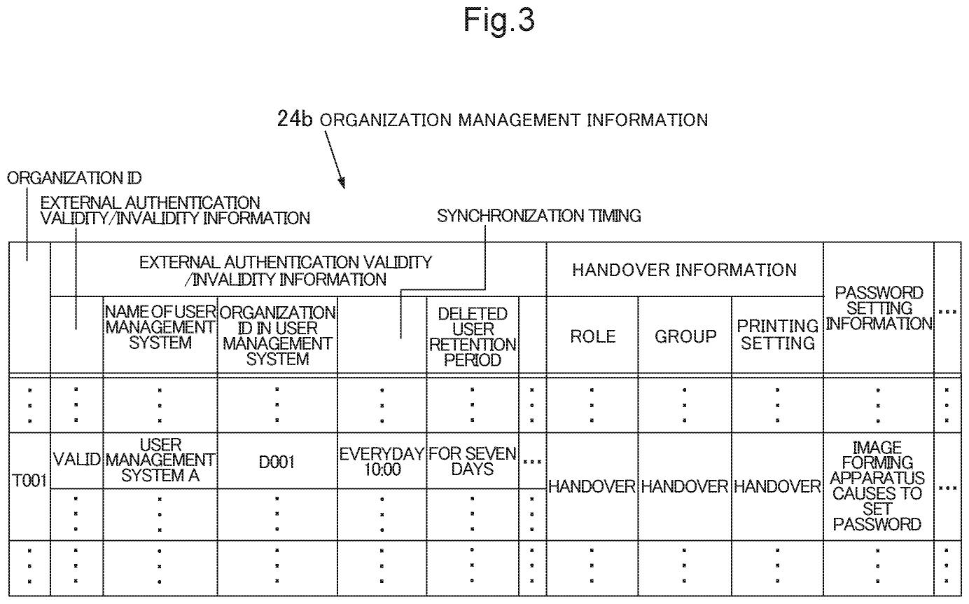

FIG. 3 is a diagram showing an example of the organization management information 24b. As shown in FIG. 3, the organization management information 24b includes an organization ID as identification information of an organization, external authentication setting information indicating a setting regarding a user management system, handover information indicating whether to handover various settings in a case where a user (hereinafter, referred to as an “external user”) imported from a user management system to the service providing apparatus 20 is changed to a user (hereinafter, referred to as a “local user”) specific to the service providing apparatus 20, and password setting information indicating whether a user is caused to set a password from an image forming apparatus in a case where the user logs into the service providing apparatus 20 from the image forming apparatus, for each organization in the service providing apparatus 20. In the organization management information 24b shown in FIG. 3, some pieces of information are omitted.

The external authentication setting information includes external authentication validity/invalidity information indicating whether to validate authentication by a user management system, a name of a user management system, an organization ID in a user management system, a synchronization timing indicating a timing at which synchronization of a user from a user management system is regularly executed, and a deleted user retention period indicating a period during which a user deleted from a user management system is retained, for each user management system. In the external authentication setting information shown in FIG. 3, some pieces of information are omitted.

The deleted user retention period may be set, for example, between 0 to 28 days.

As the handover information, there is handover information regarding a role, a group, and a printing setting.

In a case where “HANDOVER” is shown in the handover information regarding a role, when a user is changed from an external user to a local user, a role of the user in the service providing apparatus 20 is maintained without change. On the other hand, in a case where “NOT HANDOVER” is shown in the handover information regarding a role, when a user is changed from an external user to a local user, a role of the user in the service providing apparatus 20 becomes a “general user”.

In a case where “HANDOVER” is shown in the handover information regarding a group, when a user is changed from an external user to a local user, a group to which the user belongs is maintained without change. On the other hand, in a case where “NOT HANDOVER” is shown in the handover information regarding a group, when a user is changed from an external user to a local user, a group to which the user belongs becomes “default group”.

In a case where “HANDOVER” is shown in the handover information regarding a printing setting, when a user is changed from an external user to a local user, an upper limit (hereinafter, an upper limit of the number of printed sheets permitted in a specific period is referred to as “upper limit number of printed sheets”) of the number of printed sheets permitted to the user, for example, in a specific period such as one month and an upper limit (hereinafter, an upper limit of the number of color printed sheets permitted in a specific period is referred to as “upper limit number of color printed sheets”) of the number of color printed sheets permitted to the user, for example, in a specific period such as one month are maintained without change. On the other hand, when “NOT HANDOVER” is shown in the handover information regarding a printing setting, when a user is changed from an external user to a local user, the upper limit of the number of printed sheets permitted to the user in the specific period and the upper limit of the number of color printed sheets permitted to the user in the specific period are canceled.

As shown in FIG. 2, the storage device 24 stores group management information 24c for managing a group to which a user of the service providing apparatus 20 belongs.

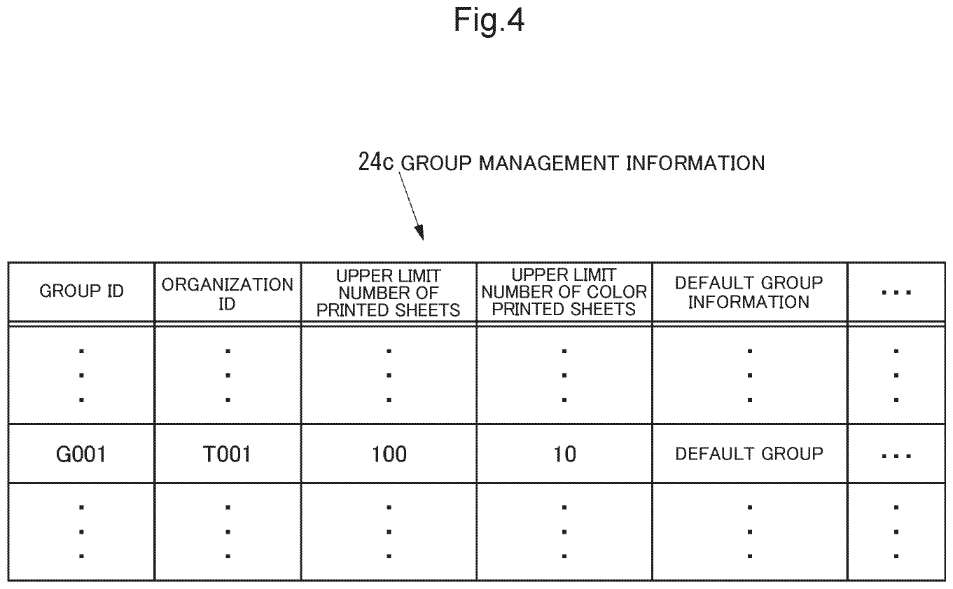

FIG. 4 is a diagram showing an example of the group management information 24c. As shown in FIG. 4, the group management information 24c includes a group ID as identification information of a group, an organization ID of an organization to which a group belongs, an upper limit number of printed sheets to a group, a upper limit number of color printed sheets to a group, and default group information as information indicating whether a group is a default group, for each group in the service providing apparatus 20. In the group management information 24c shown in FIG. 4, some pieces of information are omitted.

In the default group information, only one group among groups belonging to the same organization is shown as a default group. That is, one default group is set for each organization ID.

As shown in FIG. 2, the storage device 24 stores user management information 24d for managing a user of the service providing apparatus 20.

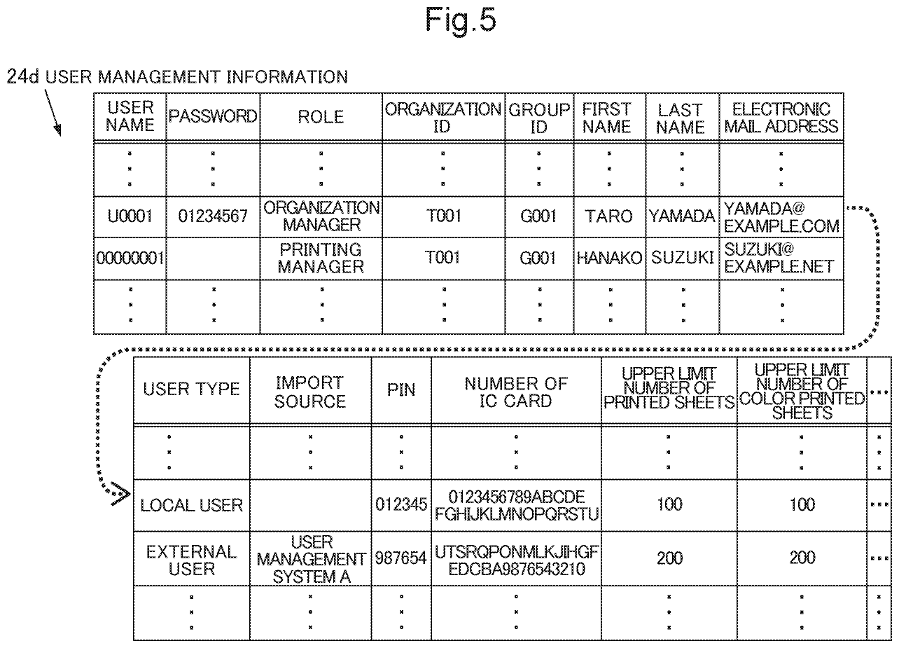

FIG. 5 is a diagram showing an example of the user management information 24d. As shown in FIG. 5, the user management information 24d includes a user name as identification information of a user, a password of a user, a role of a user, an organization ID as identification information of an organization to which a user belongs, a group ID as identification information of a group to which a user belongs, a first name of a user, a last name of a user, an electronic mail address of a user, a user type indicating one of a local user and an external user, a name of a user management system as an import source of a user who is an external user, a personal identification number (PIN) of a user for logging into the service providing apparatus 20 from an image forming apparatus, a number of an integrated circuit (IC) card of a user for logging into the service providing apparatus 20 from an image forming apparatus, an upper limit number of printed sheets to a user, and an upper limit number of color printed sheets to a user, for each user of the service providing apparatus 20. In the user management information 24d shown in FIG. 5, some pieces of information are omitted.

As the role in the user management information 24d, for example, there are an organization representative as a representative of an organization to which a user belongs, an organization manager as a manager of an organization to which a user belongs, a printing manager who executes management of printing of an organization to which a user belongs, and a general user as a general user. The organization representative is only one person in one organization and is a local user. There may be a plurality of organization managers in one organization. The organization representative and the organization manager compose a manager of the present disclosure.

The user management information 24d does not store a password of a user whose user type is “external user”.

As shown in FIG. 2, the storage device 24 stores deletion suspended user information 24e indicating a user of which deletion from the user management information 24d is suspended.

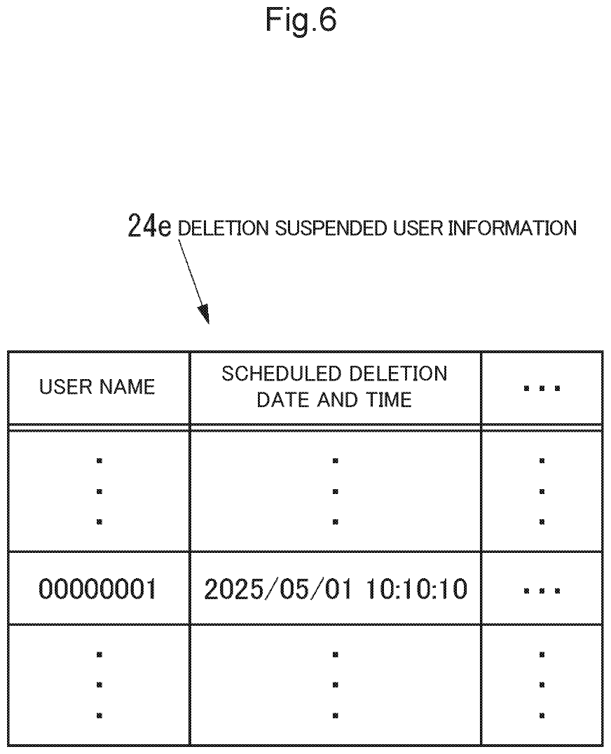

FIG. 6 is a diagram showing an example of the deletion suspended user information 24e. As shown in FIG. 6, the deletion suspended user information 24e includes a user name of a user of which deletion from the user management information 24d is suspended and scheduled deletion date and time from the user management information 24d, for each user. In the deletion suspended user information 24e shown in FIG. 6, some pieces of information are omitted.

The control device 25 shown in FIG. 2 includes, for example, a central processing unit (CPU) as an example of a processor, a read only memory (ROM) that stores programs and various kinds of data, and a random access memory (RAM) as a memory that is used as a work area of the above-described CPU. The above-described CPU executes a program stored in the storage device 24 or the ROM of the control device 25. The above-described processor is an example of a computer.

The control device 25 functions as a service provider 25a that provides a specific service to a user, by executing the service providing program 24a.

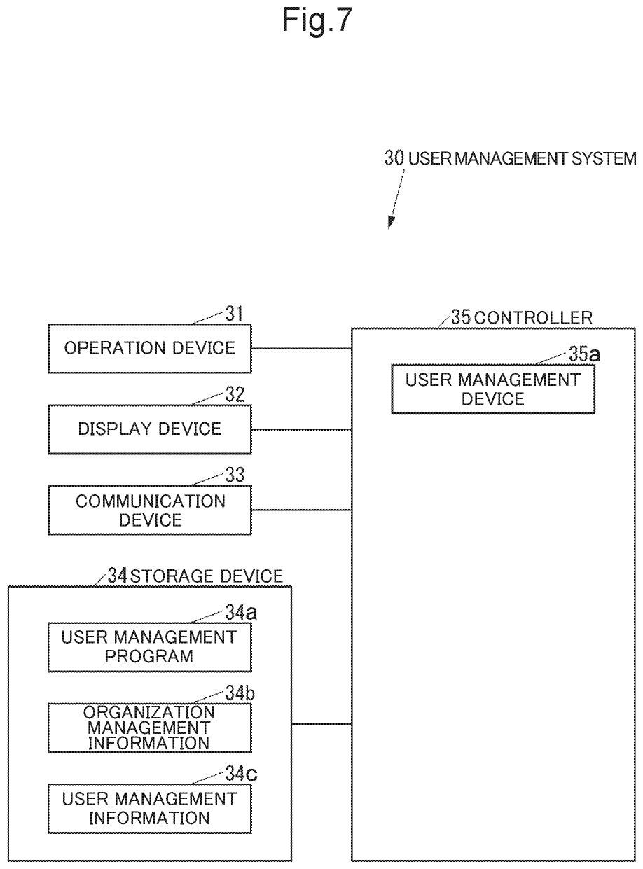

FIG. 7 is a block diagram of an example of the user management system 30 in the case of being configured with one computer.

As shown in FIG. 7, the user management system 30 includes an operation device 31 that is, for example, an operation device to which various operations are input, such as a keyboard and a mouse, a display device 32 that is, for example, a display device configured to display various kinds of information such as an LCD, a communication device 33 that is a communication device configured to perform communication with an external apparatus via a network such as a LAN or the Internet or directly in a wired or wireless manner not via a network, a storage device 34 that is, for example, a nonvolatile storage device configured to store various kinds of information such as a semiconductor memory or an HDD, and a controller 35 that controls the entire user management system 30.

The storage device 34 stores a user management program 34a for managing a user. The user management program 34a may be installed on the storage device 34 in a manufacturing step of the user management system 30, may be additionally installed on the storage device 34 from an external storage medium such as a universal serial bus (USB) memory, or may be additionally installed on the storage device 34 from a network, for example.

The storage device 34 stores organization management information 34b for managing an organization to which a user of the user management system 30 belongs.

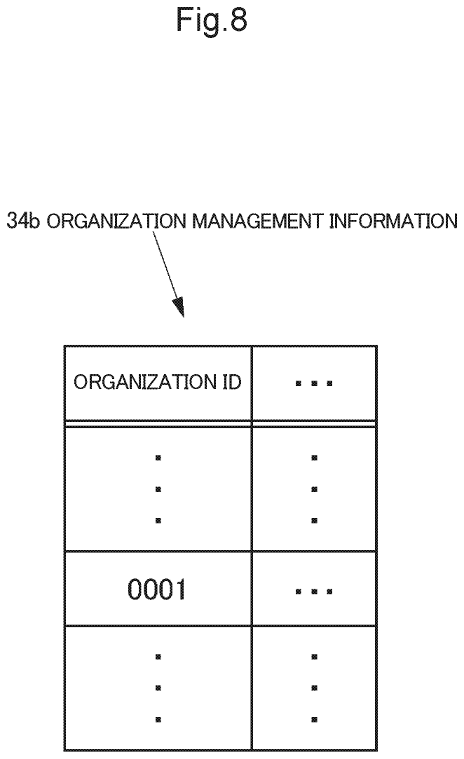

FIG. 8 is a diagram showing an example of organization management information 34b. As shown in FIG. 8, the organization management information 34b includes an organization ID as identification information of an organization for each organization in the user management system 30. In the organization management information 34b shown in FIG. 8, some pieces of information are omitted.

The organization ID in the organization management information 34b is a tenant name in the user management system 30 in a case where the user management system 30 is Microsoft Entra ID. The organization ID in the organization management information 34b is a domain in the user management system 30 in a case where the user management system 30 is Google Workspace.

As shown in FIG. 7, the storage device 34 stores user management information 34c for managing a user of the user management system 30.

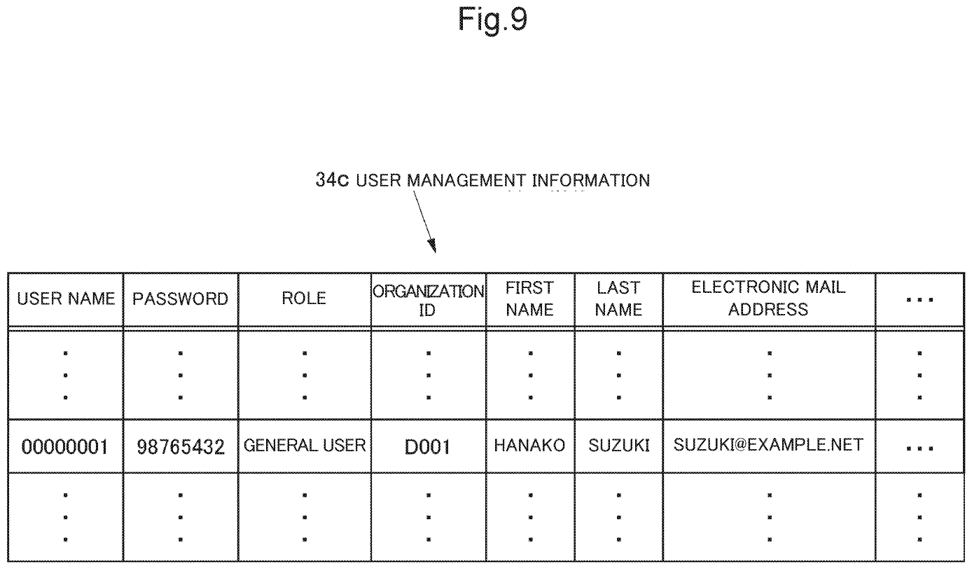

FIG. 9 is a diagram showing an example of the user management information 34c. As shown in FIG. 9, the user management information 34c includes account information including a user name as identification information of a user, a password of a user, a role of a user, an organization ID as identification information of an organization to which a user belongs, a first name of a user, a last name of a user, and an electronic mail address of a user, for each user of the user management system 30. In the user management information 34c shown in FIG. 9, some pieces of information are omitted.

As the role in the user management information 34c, for example, there are a management user who manages a user of the user management system 30 and a general user as a general user. An IT operator is a management user.

The controller 35 shown in FIG. 7 includes, for example, a CPU as an example of a processor, a ROM that stores programs and various kinds of data, and a RAM as a memory that is used as a work area of the CPU of the controller 35. The CPU of the controller 35 executes a program stored in the storage device 34 or the ROM of the controller 35.

The controller 35 functions as a user management device 35a that manages a user, by executing the user management program 34a.

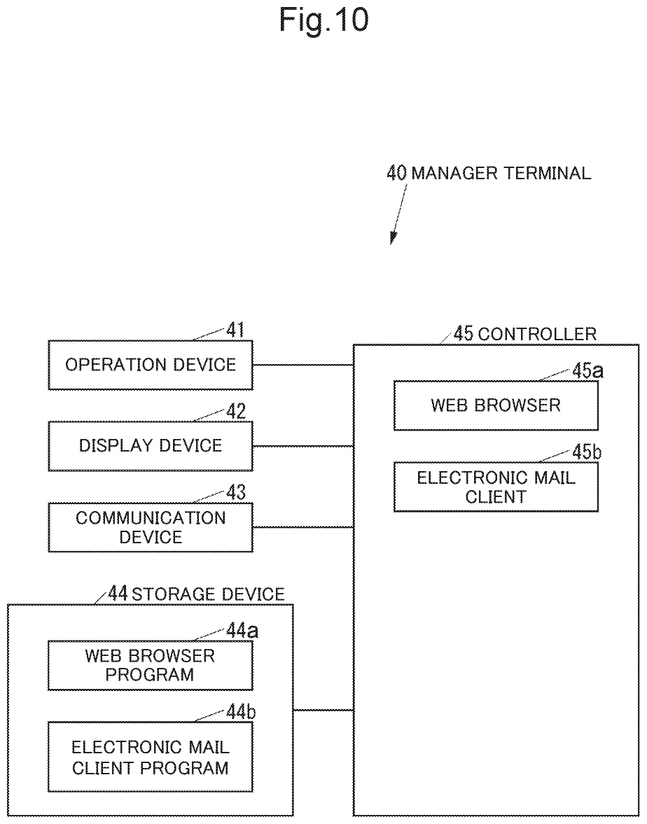

FIG. 10 is a block diagram of an example of a manager terminal 40. As shown in FIG. 10, the manager terminal 40 includes an operation device 41 that is, for example, an operation device to which various operations are input, such as a keyboard and a mouse, a display device 42 that is, for example, a display device configured to display various kinds of information such as an LCD, a communication device 43 that is a communication device configured to perform communication with an external apparatus via a network such as a LAN or the Internet or directly in a wired or wireless manner not via a network, a storage device 44 that is, for example, a nonvolatile storage device configured to store various kinds of information such as a semiconductor memory or an HDD, and a controller 45 that controls the entire manager terminal 40.

The storage device 44 stores a program 44a for web browser (hereinafter, referred to as a web browser program). The web browser program 44a may be installed on the storage device 44 in a manufacturing step of the manager terminal 40, may be additionally installed on the storage device 44 from an external storage medium such as a USB memory, or may be additionally installed on the storage device 44 from a network, for example.

The storage device 44 stores a program 44b for electronic mail client (hereinafter, an electronic mail client program). The electronic mail client program 44b may be installed on the storage device 44 in a manufacturing step of the manager terminal 40, may be additionally installed on the storage device from an external storage medium such as a USB memory, or may be additionally installed on the storage device 44 from a network, for example.

The controller 45 includes, for example, a CPU as an example of a processor, a ROM that stores programs and various kinds of data, and a RAM as a memory that is used as a work area of the CPU of the controller 45. The CPU of the controller 45 executes a program stored in the storage device 44 or the ROM of the controller 45.

The controller 45 functions as a web browser 45a by executing the web browser program 44a.

The controller 45 functions as an electronic mail client 45b by executing the electronic mail client program 44b.

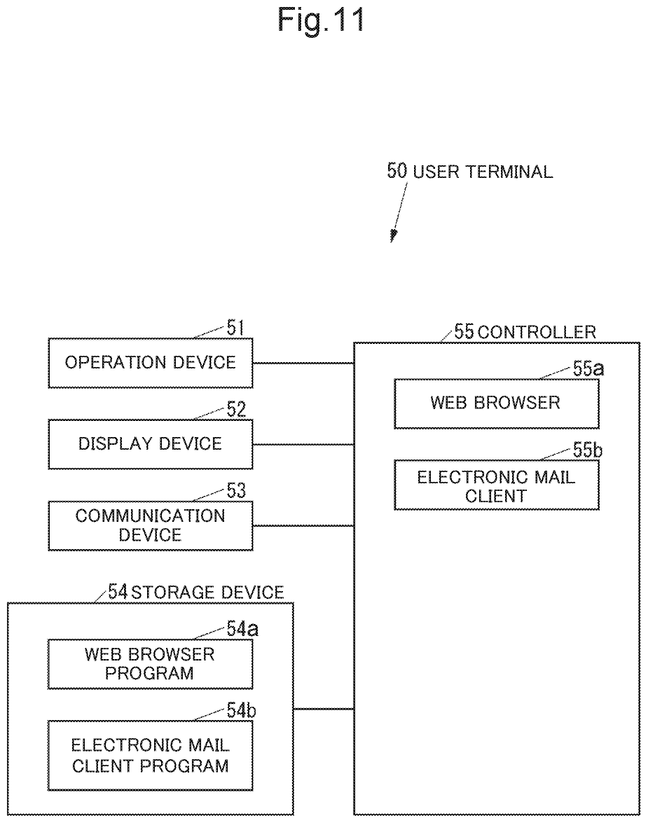

FIG. 11 is a block diagram of an example of a user terminal 50. As shown in FIG. 11, the user terminal 50 includes an operation device 51 that is, for example, an operation device to which various operations are input, such as a keyboard and a mouse, a display device 52 that is, for example, a display device configured to display various kinds of information such as an LCD, a communication device 53 that is a communication device configured to perform communication with an external apparatus via a network such as a LAN or the Internet or directly in a wired or wireless manner not via a network, a storage device 54 that is, for example, a nonvolatile storage device configured to store various kinds of information such as a semiconductor memory or an HDD, and a controller 55 that controls the entire user terminal 50.

The storage device 54 stores a web browser program 54a. The web browser program 54a may be installed on the storage device 54 in a manufacturing step of the user terminal 50, may be additionally installed on the storage device 54 from an external storage medium such as a USB memory, or may be additionally installed on the storage device 54 from a network, for example.

The storage device 54 stores an electronic mail client program 54b. The electronic mail client program 54b may be installed on the storage device 54 in a manufacturing step of the user terminal 50, may be additionally installed on the storage device 54 from an external storage medium such as a USB memory, or may be additionally installed on the storage device 54 from a network, for example.

The controller 55 includes, for example, a CPU as an example of a processor, a ROM that stores programs and various kinds of data, and a RAM as a memory that is used as a work area of the CPU of the controller 55. The CPU of the controller 55 executes a program stored in the storage device 54 or the ROM of the controller 55.

The controller 55 functions as a web browser 55a by executing the web browser program 54a. The controller 55 functions as an electronic mail client 55b by executing the electronic mail client program 54b.

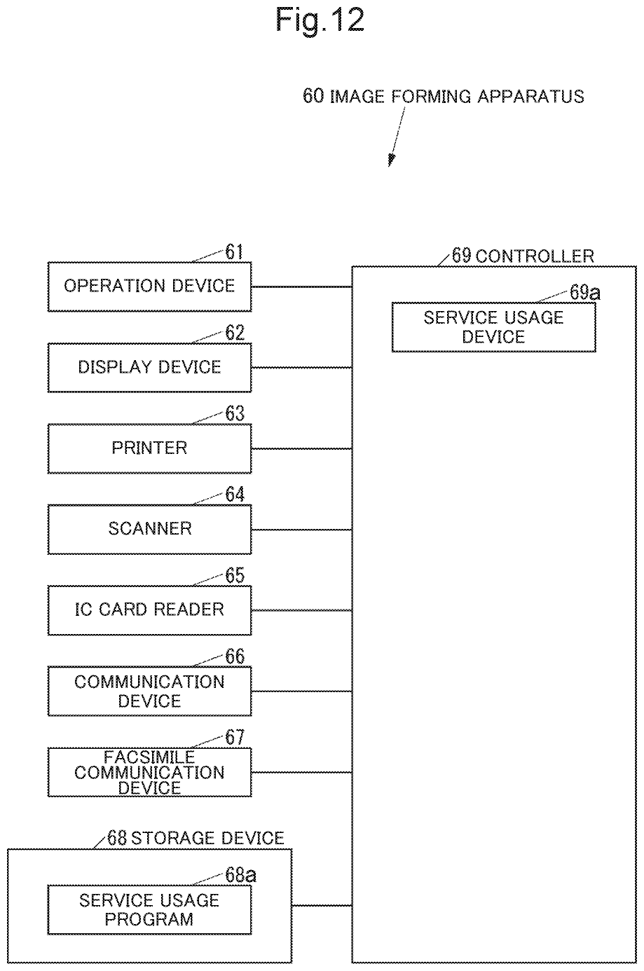

FIG. 12 is a block diagram of an example of an image forming apparatus 60 in the case of being configured with an MFP.

As shown in FIG. 12, the image forming apparatus 60 is a computer including an operation device 61 that is an operation device to which various operations are input, such as a button, a display device 62 that is, for example, a display device configured to display various kinds of information such as an LCD, a printer 63 that is a printing device configured to print an image on a recording medium such as a sheet, a scanner 64 that is a reading device configured to read an image from a document, an IC card reader 65 that reads information from an IC card, a communication device 66 that is a communication device configured to perform communication with an external apparatus via a network such as a LAN or the Internet or directly in a wired or wireless manner not via a network, a facsimile communication device 67 that is a facsimile device configured to perform facsimile communication with an external facsimile apparatus (not shown) via a communication line such as a public telephone line, a storage device 68 that is, for example, a nonvolatile storage device configured to store various kinds of information such as a semiconductor memory or an HDD, and a controller 69 that controls the entire image forming apparatus 60.

The storage device 68 stores a service usage program 68a for using a service to be provided by the service providing apparatus 20. The service usage program 68a may be installed on the image forming apparatus 60 in a manufacturing step of the image forming apparatus 60, may be additionally installed on the image forming apparatus 60 from an external storage medium such as a USB memory, or may be additionally installed on the image forming apparatus 60 from a network, for example.

The controller 69 includes, for example, a CPU, a ROM that stores programs and various kinds of data, and a RAM as a memory that is used as a work area of the CPU of the controller 69. The CPU of the controller 69 executes a program stored in the storage device 68 or the ROM of the controller 69.

The controller 69 functions as a service usage device 69a that uses a service to be provided by the service providing apparatus 20, by executing the service usage program 68a.

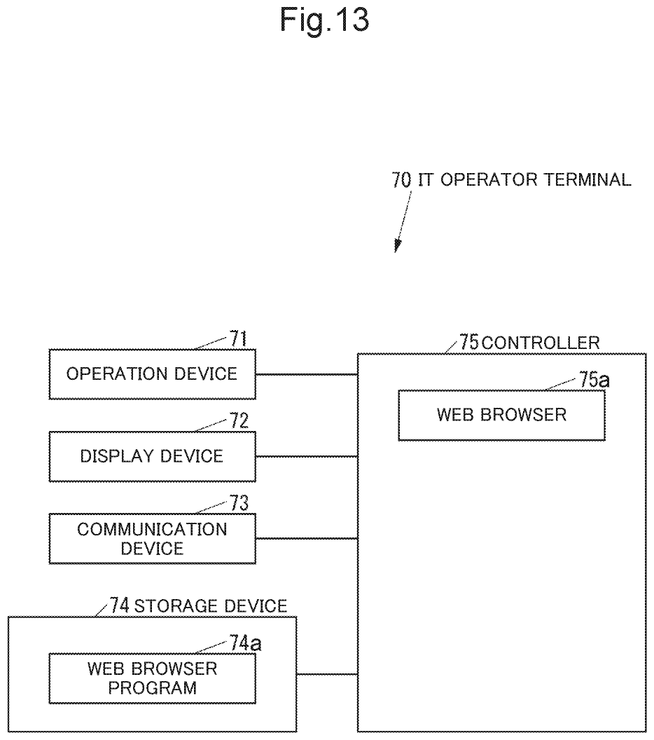

FIG. 13 is a block diagram of an example of an IT operator terminal 70. As shown in FIG. 13, the IT operator terminal 70 includes an operation device 71 that is, for example, an operation device to which various operations are input, such as a keyboard and a mouse, a display device 72 that is, for example, a display device configured to display various kinds of information such as an LCD, a communication device 73 that is a communication device configured to perform communication with an external apparatus via a network such as a LAN or the Internet or directly in a wired or wireless manner not via a network, a storage device 74 that is, for example, a nonvolatile storage device configured to store various kinds of information such as a semiconductor memory or an HDD, and a controller 75 that controls the entire IT operator terminal 70.

The storage device 74 stores a web browser program 74a. The web browser program 74a may be installed on the storage device 74 in a manufacturing step of the IT operator terminal 70, may be additionally installed on the storage device 74 from an external storage medium such as a USB memory, or may be additionally installed on the storage device 74 from a network, for example.

The controller 75 includes, for example, a CPU as an example of a processor, a ROM that stores programs and various kinds of data, and a RAM as a memory that is used as a work area of the CPU of the controller 75. The CPU of the controller 75 executes a program stored in the storage device 74 or the ROM of the controller 75.

The controller 75 functions as a web browser 75a by executing the web browser program 74a.

Next, an operation of the system 10 will be described. First, an operation of the system 10 in a case where the IT operator logs into a user management system via a web browser of an IT operator terminal will be described.

Hereinafter, an operation of the system 10 in a case where the IT operator logs into the user management system 30 via the web browser 75a of the IT operator terminal 70 will be described as an example.

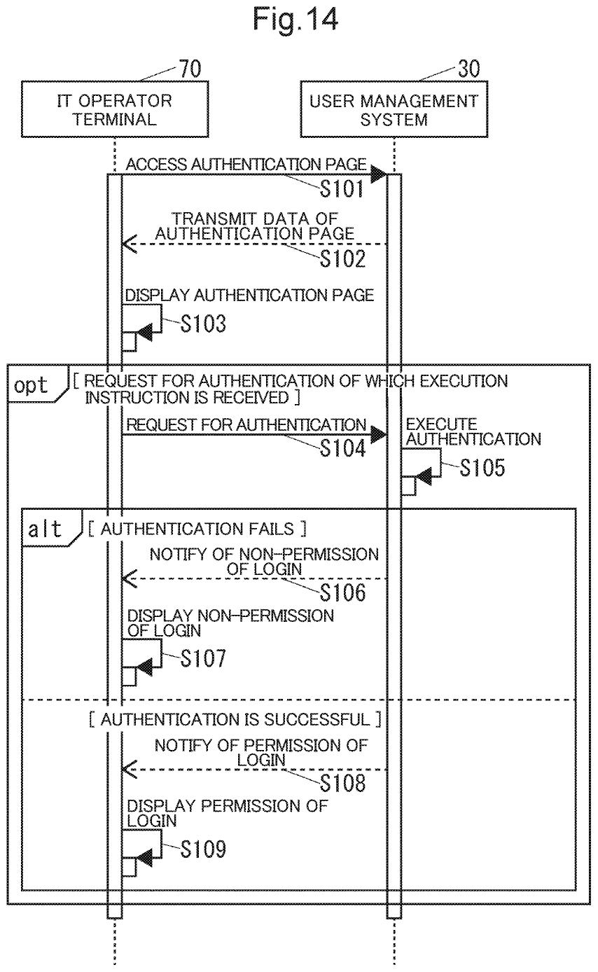

FIG. 14 is a sequence diagram of an operation of the system 10 in a case where the IT operator logs into the user management system 30 via the web browser 75a of the IT operator terminal 70.

The IT operator instructs an access request to a web page (hereinafter, referred to as an “authentication page” in description of the operation shown in FIG. 14) for authentication of a user of the user management system 30 to the IT operator terminal 70 via the operation device 71 of the IT operator terminal 70. When an access to the authentication page is instructed, the web browser 75a of the IT operator terminal 70 accesses the authentication page (S101).

When there is an access to the authentication page in S101, the user management device 35a of the user management system 30 transmits data of the authentication page to the web browser 75a of the IT operator terminal 70 (S102).

When the data of the authentication page transmitted in S102 is received, the web browser 75a displays the authentication page on the display device 72 on the basis of the received data (S103). The authentication page displayed in S103 displays an image for receiving input of a user name as identification information of a user and a password of a user. The authentication page displayed in S103 displays a message for prompting to input a user name, a password, and an authentication execution instruction.

After the processing of S103 ends, when the user name, the password, and the authentication execution instruction are received via the authentication page, the web browser 75a requests the user management system 30 for authentication of a user (S104). The web browser 75a includes, in the request in S104, a combination of a user name and a password received at a point of time at which the instruction to execute authentication is received.

When the request is received in S104, the user management device 35a of the user management system 30 executes authentication based on the combination of the user name and the password included in the request in S104 (S105). Specifically, the user management device 35a determines that the authentication of the user is successful when the combination of the user name and the password included in the request in S104 is included in the user management information 34c. On the other hand, the user management device 35a determines that the authentication of the user fails when the combination of the user name and the password included in the request in S104 is not included in the user management information 34c.

When determination is made that the authentication executed in S105 fails, the user management device 35a notifies the web browser 75a of the IT operator terminal 70 of non-permission of login (S106).

When the notification is received in S106, the web browser 75a displays non-permission of login on the display device 72 of the IT operator terminal 70 (S107).

When determination is made that the authentication executed in S105 is successful, the user management device 35a of the user management system 30 notifies the web browser 75a of the IT operator terminal 70 of permission of login (S108).

When the notification in S108 is received, the web browser 75a displays permission of login on the display device 72 of the IT operator terminal 70 (S109).

In a case where the IT operator has logged into the user management system 30 as a management user via the web browser 75a of the IT operator terminal 70, when an instruction to add a user to an organization to which the IT operator himself/herself belongs, an instruction to change various kinds of information of a user who belongs to the organization to which the IT operator himself/herself belongs, an instruction to delete a user who belongs to the organization to which the IT operator himself/herself belongs, and the like are input to the web browser 75a by an operation of the IT operator, the web browser 75a transmits these instructions to the user management system 30. The user management device 35a of the user management system 30 adds a user to the organization to which the IT operator himself/herself belongs, changes various kinds of information of a user who belongs to the organization to which the IT operator himself/herself belongs, or deletes a user who belongs to the organization to which the IT operator himself/herself belongs by changing the user management information 34c according to an instruction from the IT operator.

Next, an operation of the system 10 in a case where a manager logs into the service providing apparatus 20 via a web browser of a manager terminal 40 will be described.

Hereinafter, the operation of the system 10 in a case where the manager logs into the service providing apparatus 20 via the web browser 45a of the manager terminal 40 will be described as an example.

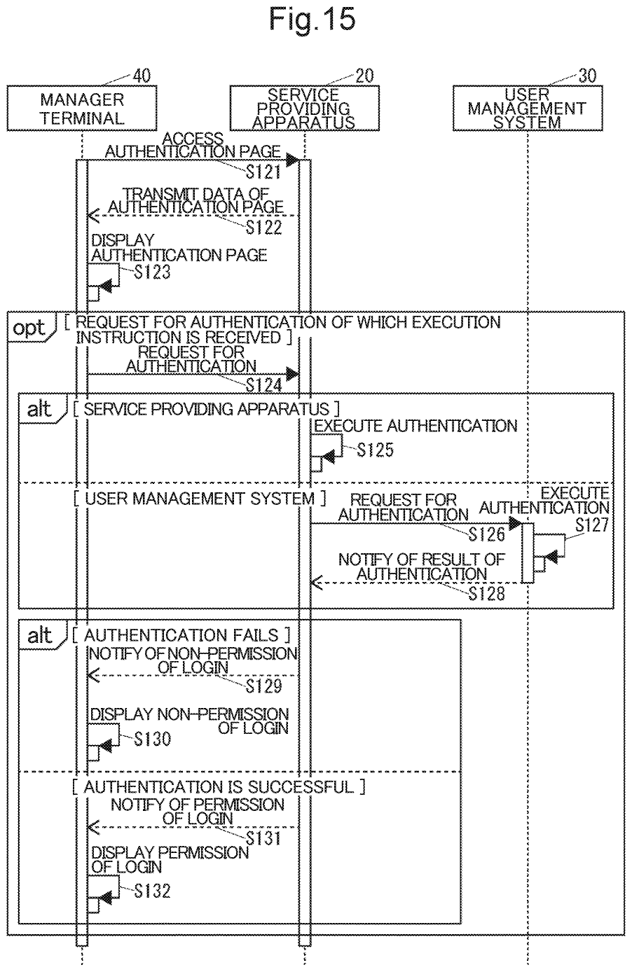

FIG. 15 is a sequence diagram of an operation of the system 10 in a case where the manager logs into the service providing apparatus 20 via the web browser 45a of the manager terminal 40.

The manager inputs an access request to a web page (hereinafter, referred to as an “authentication page” in description of the operation shown in FIG. 15) for authentication of a user of the service providing apparatus 20 to the operation device 41 of the manager terminal 40. When the access request to the authentication page is input to the operation device 41, the web browser 45a of the manager terminal 40 accesses the authentication page (S121).

When the authentication page is accessed in S121, the service provider 25a of the service providing apparatus 20 transmits data of the authentication page to the web browser 45a of the manager terminal 40 (S122).

When the data of the authentication page transmitted in S122 is received, the web browser 45a displays the authentication page on the display device 42 on the basis of the received data (S123). The authentication page displayed by the web browser 45a in S123 displays an image for receiving selection of a name of a system (hereinafter, referred to as an “authentication execution system”) that executes authentication. The name of the authentication execution system selectable by the authentication page displayed in S123 is, for example, “service providing apparatus” as a name of the service providing apparatus 20. The name of the authentication execution system selectable by the authentication page displayed in S123 is, for example, a name of a user management system for which authentication is valid in the external authentication validity/invalidity information of the external authentication setting information. During the display of the authentication page displayed in S123, the above-described web browser 45a receives a user name as identification information of a user, a password of a user, and an authentication execution instruction.

After the processing of S123 ends, when the authentication execution instruction is received in the authentication page, the web browser 45a requests the service providing apparatus 20 for authentication of the user (S124). The web browser 45a includes, in the request in S124, the name of the authentication execution system selected in the authentication page at a point of time at which the authentication execution instruction is received and a combination of the user name and the password input to the authentication page at a point of time at which the authentication execution instruction is received.

In a case where the request is received in S124, when the name of the authentication execution system included in the request in S124 is “service providing apparatus”, the service provider 25a of the service providing apparatus 20 executes authentication based on the combination of the user name and the password included in the request in S124 (S125). Specifically, the service provider 25a determines that the authentication of the user is successful in a case where the combination of the user name and the password included in the request in S124 is included in the user management information 24d. On the other hand, the service provider 25a determines that the authentication of the user fails in a case where the combination of the user name and the password included in the request in S124 is not included in the user management information 24d.

In a case where the request is received in S124, when the name of the authentication execution system included in the request in S124 is a name of any one user management system, the service provider 25a of the service providing apparatus 20 requests a user management system of which the name is included in the request in S124 for authentication based on the combination of the user name and the password included in the request in S124 (S126). Hereinafter, description will be provided assuming that a user management system as a target of the request in S126 is the user management system 30.

When the request is received in S126, the user management device 35a of the user management system 30 executes authentication the combination of the user name and the password included in the request in S126 (S127). Specifically, the user management device 35a determines that the authentication of the user is successful in a case where the combination of the user name and the password included in the request in S126 is included in the user management information 34c. On the other hand, the user management device 35a determines that the authentication of the user fails in a case where the combination of the user name and the password included in the request in S126 is not included in the user management information 34c.

When the authentication ends in S127, the user management device 35a notifies the service providing apparatus 20 of a result of the authentication in S127 (S128).

When determination is made that the authentication executed in S125 fails or when the failure of the authentication is notified in S128, the service provider 25a of the service providing apparatus 20 notifies the web browser 45a of the manager terminal 40 of non-permission of login (S129).

When the notification is received in S129, the web browser 45a displays non-permission of login on the display device 42 of the manager terminal 40 (S130).

When determination is made that the authentication executed in S125 is successful or when the success of the authentication is notified in S128, the service provider 25a of the service providing apparatus 20 notifies the web browser 45a of the manager terminal 40 of permission of login (S131).

When the notification is received in S131, the web browser 45a notifies the display device 42 of the manager terminal 40 of permission of login (S132).

In the above description, the operation for the manager to log into the service providing apparatus 20 via the web browser 45a of the manager terminal 40 is described. It should be noted that a similar operation is performed even in a case where a user logs into the service providing apparatus 20 via a web browser of a user terminal.

In a case where the manager has logged into the service providing apparatus 20 via the web browser 45a of the manager terminal 40, the manager instructs the service providing apparatus 20 to change various kinds of information of an organization to which the manager himself/herself belongs, via the web browser 45a. The service provider 25a of the service providing apparatus 20 changes various kinds of information in the organization management information 24b according to an instruction from the manager.

In a case where the manager has logged into the service providing apparatus 20 via the web browser 45a of the manager terminal 40, the manager instructs the service providing apparatus 20 to add a group to an organization to which the manager himself/herself belongs, change various kinds of information of a group belonging to the organization to which the manager himself/herself belongs, or delete a group belonging to organization to which the manager himself/herself belongs, via the web browser 45a. The service provider 25a of the service providing apparatus 20 adds a group to the organization to which the manager himself/herself belongs, changes various kinds of information of a group belonging to the organization to which the manager himself/herself belongs, or deletes a group belonging to the organization to which the manager himself/herself belongs, by changing the group management information 24c according to an instruction from the manager.

In a case where the manager has logged into the service providing apparatus 20 via the web browser 45a of the manager terminal 40, the manager instructs the service providing apparatus 20 to add a user to an organization to which the manager himself/herself belongs, change various kinds of information of a user who belongs to the organization to which the manager himself/herself belongs, or delete a user who belongs to the organization to which the manager himself/herself belongs, via the web browser 45a. The service provider 25a of the service providing apparatus 20 adds a user to the organization to which the manager himself/herself belongs, changes various kinds of information of a user who belongs to the organization to which the manager himself/herself belongs, or delete a user who belongs to the organization to which the manager himself/herself belongs, by changing the user management information 24d according to an instruction from the manager.

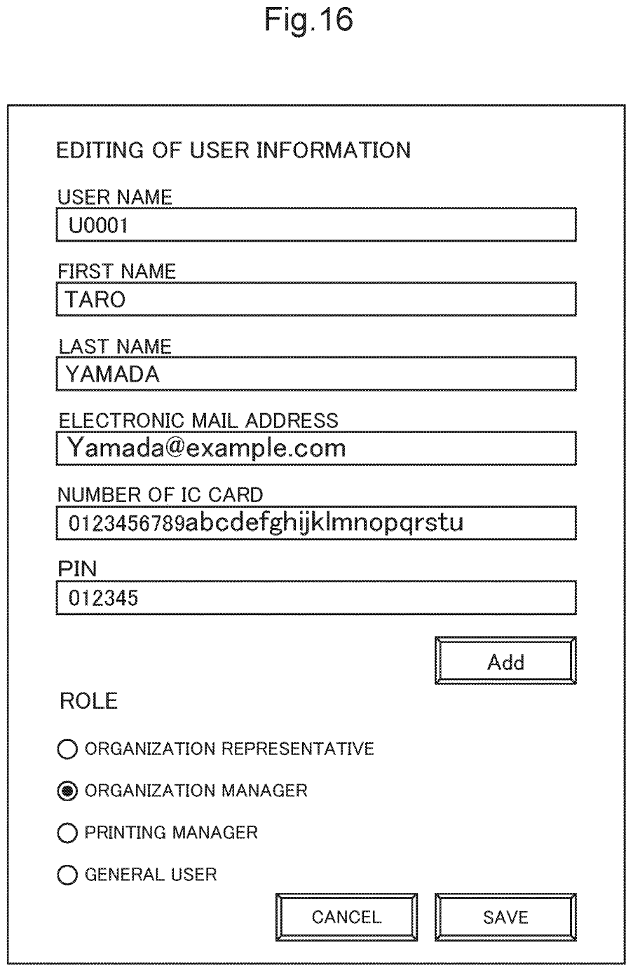

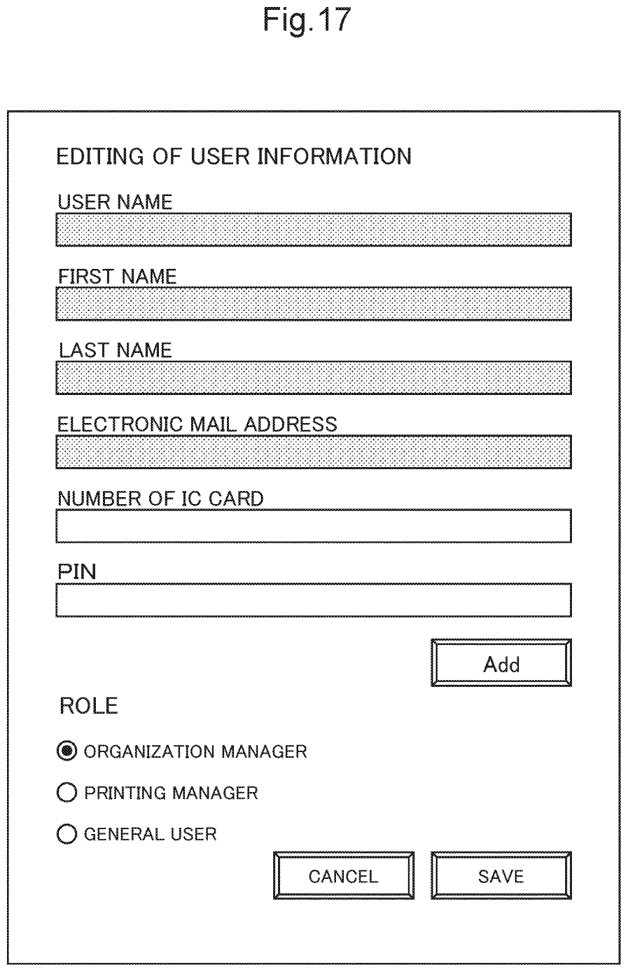

FIG. 16 is an editing screen of information of a user specific to the service providing apparatus 20. FIG. 17 is an editing screen of information of a user imported from the user management system 30.

In a case where editing of information of a user specific to the service providing apparatus 20, that is, a local user is instructed from the web browser 45a, the service provider 25a of the service providing apparatus 20 causes the web browser 45a to display the editing screen as shown in FIG. 16.

In a case where editing of information of a user imported from the user management system 30, that is, an external user is instructed from the web browser 45a, the service provider 25a of the service providing apparatus 20 causes the web browser 45a to display the editing screen as shown in FIG. 17. A user name, a first name, a last name, and an electronic mail address of a user imported from the user management system 30 are received from the user management system 30 and synchronized. Accordingly, on the editing screen shown in FIG. 17, these items are grayed out and are made not to be changed.

Next, an operation of the service providing apparatus 20 in the case of synchronizing a user who is managed by the user management system 30 with the service providing apparatus 20 will be described.

In a case where the manager has logged into the service providing apparatus 20 via the web browser 45a of the manager terminal 40, the manager instructs the service providing apparatus 20 to synchronize a user who is managed by a specific user management system 30, with the service providing apparatus 20 via the web browser 45a.

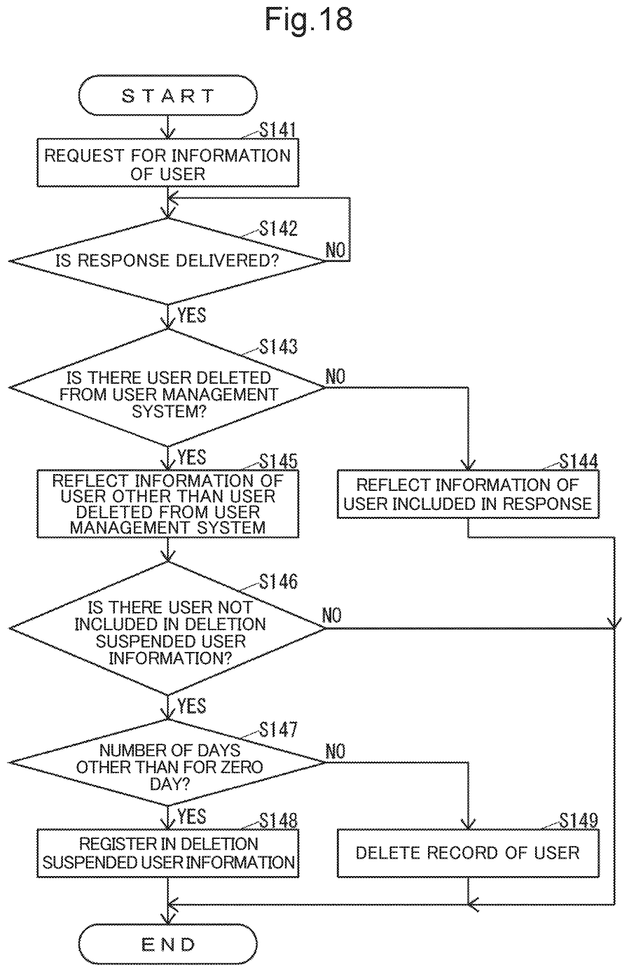

Hereinafter, a case where the manager instructs the service providing apparatus 20 to synchronize a user who is managed by the user management system 30, with the service providing apparatus 20 will be described as an example. FIG. 18 is a flowchart of an operation of the service providing apparatus 20 in the case of synchronizing a user who is managed by the user management system 30, with the service providing apparatus 20.

When the synchronization of the user of the user management system 30 is instructed, the service provider 25a of the service providing apparatus 20 executes an operation shown in FIG. 18.

As shown in FIG. 18, the service provider 25a requests the user management system 30 for information of a user who belongs to an organization specified by the organization ID in the user management system 30 that is shown in the external authentication setting information in the organization management information 24b associated with the organization ID to which the manager who instructs the synchronization of the user of the user management system 30 belongs (S141).

After the processing of S141 ends, the service provider 25a determines whether a response is delivered from the user management system 30 until determination is made that a response is delivered from the user management system 30 (S142). Information of the user included in the response delivered from the user management system 30 is the user name, the first name, the last name, and the electronic mail address of the user.

When determination is made in S142 that a response is delivered from the user management system 30 (in S142, YES), the service provider 25a determines whether there is a user deleted from the user management system 30, on the basis of the response delivered from the user management system 30 and the user management information 24d (S143).

When determination is made in S143 that there is no user deleted from the user management system 30 (in S143, NO), the service provider 25a reflects account information that is information of the user included in the response delivered from the user management system 30, in the user management information 24d (S144). That is, the service provider 25a imports an external user indicated by the above-described account information received as the above-described response from the user management system 30 as an external user that is a target to be managed in the service providing apparatus 20.

When determination is made in S143 that there is a user deleted from the user management system 30 (in S143, YES), the service provider 25a reflects information of a user other than the user deleted from the user management system 30 in the user management information 24d (S145).

When the processing of S145 ends, the service provider 25a determines whether there is a user not included in the deletion suspended user information 24e among users in the user management information 24d deleted from the user management system 30 (S146).

When determination is made in S146 that there is a user not included in the deletion suspended user information 24e among the users in the user management information 24d deleted from the user management system 30 (in S146, YES), the service provider 25a determines whether the deleted user retention period of the user management system 30 in the organization management information 24b is set to the number of days other than for zero day (S147).

When determination is made in S147 that the deleted user retention period in the organization management information 24b is set to the number of days other than for zero day (in S147, YES), the service provider 25a registers, in the deletion suspended user information 24e, the user not included in the deletion suspended user information 24e among the users in the user management information 24d deleted from the user management system 30 in association with date and time after a period indicated by the deleted user retention period of the user management system 30 in the organization management information 24b from current date and time (S148).

When determination is made in S147 that the deleted user retention period of the user management system 30 in the organization management information 24b is set to for zero day (in S147, NO), the service provider 25a deletes, from the user management information 24d, a record of a user not included in the deletion suspended user information 24e among the users in the user management information 24d deleted from the user management system 30 (S149).

When the processing of S144 is executed, when determination is made in S146 that there is no user not included in the deletion suspended user information 24e among the users in the user management information 24d deleted from the user management system 30 (in S146, NO), or when the processing of S148 or S149 is executed, the service provider 25a ends the operation shown in FIG. 18.

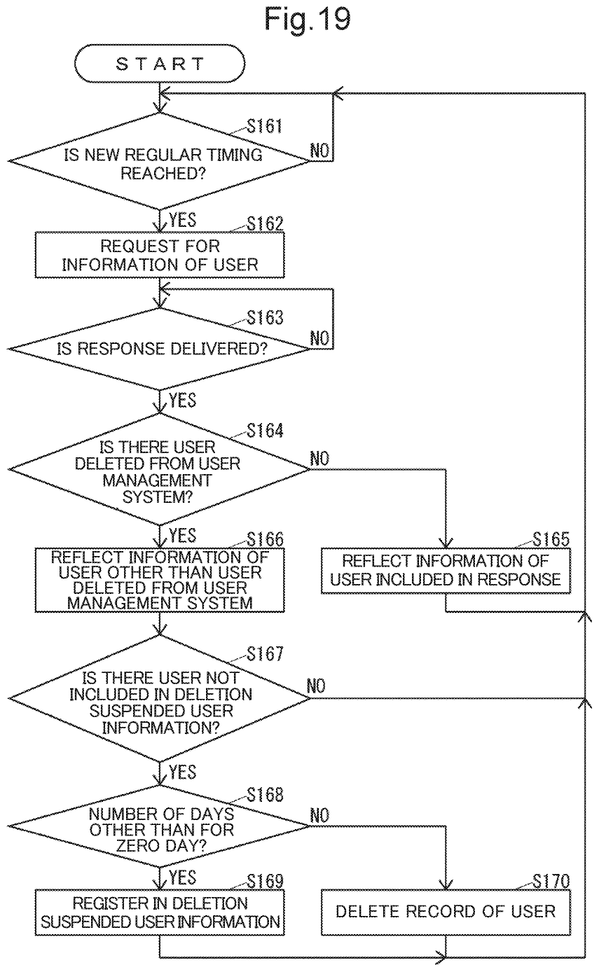

Next, an operation of the service providing apparatus 20 in the case of automatically executing synchronization of a user of a user management system will be described. FIG. 19 is a flowchart of an operation of the service providing apparatus 20 in the case of automatically executing synchronization of a user of the user management system 30.

In a case where the synchronization timing of the user management system 30 in the organization management information 24b is set on an organization in the service providing apparatus 20, the service provider 25a of the service providing apparatus 20 executes the operation shown in FIG. 19 on the organization (hereinafter, referred to as a “target organization” in description of the operation shown in FIG. 19).

As shown in FIG. 19, the service provider 25a determines whether a new regular timing is reached after a previous regular timing has elapsed, on the basis of the synchronization timing of the user management system 30 set in the organization management information 24b on the target organization until determination is made that the new regular timing is reached after the previous regular timing has elapsed (S161).

When determination is made in S161 that the new regular timing is reached after the previous regular timing has elapsed, on the basis of the synchronization timing of the user management system 30 set in the organization management information 24b on the target organization, the service provider 25a requests the user management system 30 for information of a user who belongs to an organization specified by the organization ID in the user management system 30 that is shown in the external authentication setting information in the organization management information 24b associated with the organization ID of the target organization (S162).

After the processing of S162 ends, the service provider 25a determines whether a response is delivered from the user management system 30 until determination is made that a response is delivered from the user management system 30 (S163). Information of the user included in the response delivered from the user management system 30 is a user name, a first name, a last name, and an electronic mail address of a user.

When determination is made in S163 that a response is delivered from the user management system 30, the service provider 25a determines whether there is a user deleted from the user management system 30, on the basis of the response delivered from the user management system 30 and the user management information 24d (S164).

When determination is made in S164 that there is no user deleted from the user management system 30, the service provider 25a reflects information of the user included in the response delivered from the user management system 30 in the user management information 24d (S165).

When determination is made in S164 that there is a user deleted from the user management system 30, the service provider 25a reflects information of a user other than the user deleted from the user management system 30 in the user management information 24d (S166).

When the processing of S166 ends, the service provider 25a determines whether there is a user not included in the deletion suspended user information 24e among users in the user management information 24d deleted from the user management system 30 (S167).

When determination is made in S167 that there is a user not included in the deletion suspended user information 24e among the users in the user management information 24d deleted from the user management system 30 (in S167, NO), the service provider 25a determines whether the deleted user retention period of the user management system 30 in the organization management information 24b is set to the number of days other than for zero day (S168).

When determination is made in S168 that the deleted user retention period of the user management system 30 in the organization management information 24b is set to the number of days other than for zero day (in S168, YES), the service provider 25a registers, in the deletion suspended user information 24e, the user not included in the deletion suspended user information 24e among the users in the user management information 24d deleted from the user management system 30 in association with date and time after a period shown in the deleted user retention period of the user management system 30 in the organization management information 24b from current date and time (S169).

When determination is made in S168 that the deleted user retention period of the user management system 30 in the organization management information 24b is set to for zero day (in S168, NO), the service provider 25a deletes, from the user management information 24d, a record of the user not included in the deletion suspended user information 24e among the users in the user management information 24d deleted from the user management system 30 (S170).

When the processing of S165 is executed, when determination is made in S167 that there is no user not included in the deletion suspended user information 24e among the users in the user management information 24d deleted from the user management system 30, or when the processing of S169 or S170 is executed, the service provider 25a executes the processing of S161.

Next, an operation of the service providing apparatus 20 in the case of deleting information of a user included in the deletion suspended user information 24e from the user management information 24d will be described.

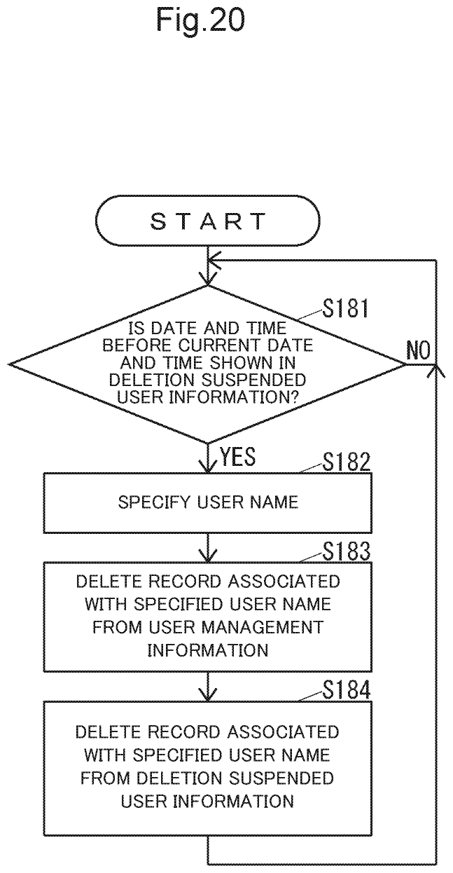

FIG. 20 is a flowchart of an operation of the service providing apparatus 20 in the case of deleting information of a user included in the deletion suspended user information 24e from the user management information 24d.

The service provider 25a of the service providing apparatus 20 executes the operation shown in the FIG. 20 in a case where a user is included in the deletion suspended user information 24e.

As shown in FIG. 20, the service provider 25a determines whether date and time before current date and time is shown in the deletion suspended user information 24e until determination is made that date and time before the current date and time is shown in the deletion suspended user information 24e (S181).

When determination is made in S181 that the date and time before the current date and time is shown in the deletion suspended user information 24e, the service provider 25a specifies a user name in the deletion suspended user information 24e associated with the date and time before the current date and time (S182).

When the processing of S182 ends, the service provider 25a deletes a record associated with the user name specified in S182 from the user management information 24d (S183).

When the processing of S183 ends, the service provider 25a deletes a record associated with the user name specified in S182 from the deletion suspended user information 24e (S184).

That is, when even an external user that has been already deleted from the user management system 30 is registered in the deletion suspended user information 24e, the service provider 25a continues to manage the external user as a local user that is managed in the service providing apparatus 20.

When the processing of S184 ends, the service provider 25a executes the processing of S181.

Next, an operation of the system 10 in a case where a user logs into the service providing apparatus 20 via an image forming apparatus will be described.

Hereinafter, as the operation of the system 10 in a case where the user logs into the service providing apparatus 20 via the image forming apparatus, an operation of the system 10 in a case where the user logs into the service providing apparatus 20 via the image forming apparatus 60 will be described as an example.

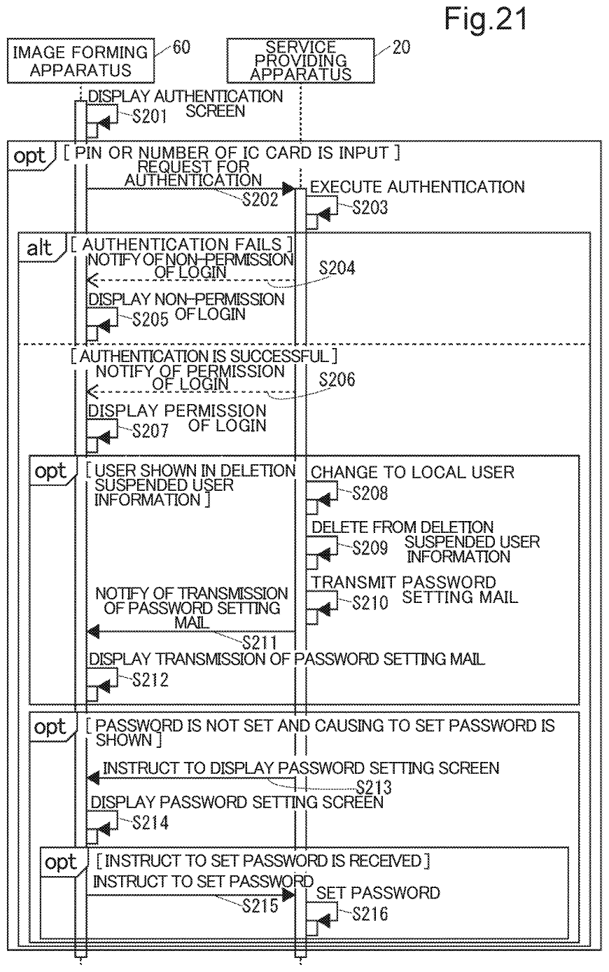

FIG. 21 is a sequence diagram of an operation of the system 10 in a case where the user logs into the service providing apparatus 20 via the image forming apparatus 60.

The user can instruct the image forming apparatus 60 to display a screen (hereinafter, referred to as an “authentication screen” in description of the operation shown in FIG. 21) for authentication of a user of the service providing apparatus 20 via the operation device 61 of the image forming apparatus 60. When the display of the authentication screen is instructed, as shown in FIG. 21, the service usage device 69a of the image forming apparatus 60 displays the authentication screen (S201). On the authentication screen displayed in S201, a PIN of the user can be input via the operation device 61. On the authentication screen displayed in S201, a number of read from an IC card of the user by the IC card reader 65 can be input.

After the processing of S201 ends, when the PIN or the number of the IC card is input on the authentication screen, the service usage device 69a requests the service providing apparatus 20 for authentication of the user (S202). The service usage device 69a includes the PIN or the number of the IC card input on the authentication screen in the request in S202.

When the request is received in S202, the service provider 25a of the service providing apparatus 20 executes authentication based on the PIN or the number of the IC card included in the request in S202 (S203). Specifically, the service provider 25a determines that the authentication of the user is successful in a case where the PIN or the number of the IC card included in the request in S202 is included in the user management information 24d. On the other hand, the service provider 25a determines that the authentication of the user fails in a case where the PIN or the number of the IC card included in the request in S202 is not included in the user management information 24d.

When determination is made that the authentication executed in S203 fails, the service provider 25a of the service providing apparatus 20 notifies the service usage device 69a of the image forming apparatus 60 of non-permission of login (S204).

When the notification is received in S204, the service usage device 69a displays non-permission of login on the display device 62 of the image forming apparatus 60 (S205).

When determination is made that the authentication executed in S203 is successful, the service provider 25a of the service providing apparatus 20 notifies the service usage device 69a of the image forming apparatus 60 of permission of login (S206).

When the notification is received in S206, the service usage device 69a displays permission of login on the display device 62 of the image forming apparatus 60 (S207).

In a case where determination is made that the authentication executed in S203 is successful, and when a user name of the user of which the authentication is successful in S203 is shown in the deletion suspended user information 24e, the service provider 25a of the service providing apparatus 20 changes a value of a user type in the user management information 24d associated with the user name to a local user (S208). The service provider 25a deletes a name of a user management system as an import source in the user management information 24d associated with the user name. In a case where “NOT HANDOVER” is shown in the handover information regarding a role in the organization management information 24b that is associated with an organization ID in the user management information 24d associated with the user name, the service provider 25a sets the role in the user management information 24d associated with the user name as a “general user”. In a case where “NOT HANDOVER” is shown in the handover information regarding a group in the organization management information 24b that is associated with the organization ID in the user management information 24d associated with the user name, the service provider 25a sets the group ID in the user management information 24d associated with the user name as a group ID of a group that is shown as the default group in the group management information 24c in association with the organization ID. In a case where “NOT HANDOVER” is shown in the handover information regarding a printing setting in the organization management information 24b that is associated with the organization ID in the user management information 24d associated with the user name, the service provider 25a deletes the values of the upper limit number of printed sheets and the upper limit number of color printed sheets in the user management information 24d associated with the user name.

When the processing of S208 ends, the service provider 25a deletes a record associated with the user name as a target to be processed in S208 from the deletion suspended user information 24e (S209).

When the processing of S209 ends, the service provider 25a transmits an electronic mail (hereinafter, referred to as a “password setting mail”) for setting a password of a user to an electronic mail address in the user management information 24d associated with the user name as a target to be processed in S208 (S210). The password setting mail includes a link to a password setting page that is a web page for setting a password of a user. The password setting page is associated with the user name as a target to be processed in S208.

When the processing of S210 ends, the service provider 25a notifies the image forming apparatus 60 that the password setting mail is transmitted (S211). The service provider 25a may include the electronic mail address of the transmission destination of the password setting mail in the notification in S211.

When the notification is received in S211, the service usage device 69a of the image forming apparatus 60 displays information indicating that the password setting mail is transmitted, on the display device 62 of the image forming apparatus 60 (S212). The service usage device 69a may include the electronic mail address of the transmission destination of the password setting mail in the display in S212.

In a case where a password in the user management information 24d is not set for the user name of the user of which the authentication is successful in S203, and causing to set a password from an image forming apparatus in a case where the user logs into the service providing apparatus 20 from the image forming apparatus is shown in the password setting information in the organization management information 24b that is associated with the organization ID in the user management information 24d associated with the user name, the service provider 25a of the service providing apparatus 20 instructs the image forming apparatus 60 to display a screen (hereinafter, referred to as a “password setting screen”) for setting a password of a user (S213).

When the instruction is received in S213, the service usage device 69a of the image forming apparatus 60 displays the password setting screen on the display device 62 of the image forming apparatus 60 according to the instruction in S213 (S214). On the password setting screen, a password desired by the user can be input. The password setting screen can receive an instruction to set a password in a state in which the password is input.

When the instruction to set a password is received on the password setting screen, the service usage device 69a instructs the service providing apparatus 20 to set the password input on the password setting screen at a point of time at which the instruction to set a password is received (S215).

When the instruction is received in S215, the service provider 25a of the service providing apparatus 20 sets the password instructed in S215 as the password in the user management information 24d associated with the user name of the user of which the authentication is successful in S203 (S216).

Next, an operation of the system 10 in a case where a user who receives a password setting mail sets a password will be described.

Hereinafter, as the operation of the system 10 in a case where the user who receives the password setting mail sets the password, an operation of the system 10 in a case where a user who receives a password setting mail at the user terminal 50 sets a password will be described as an example.

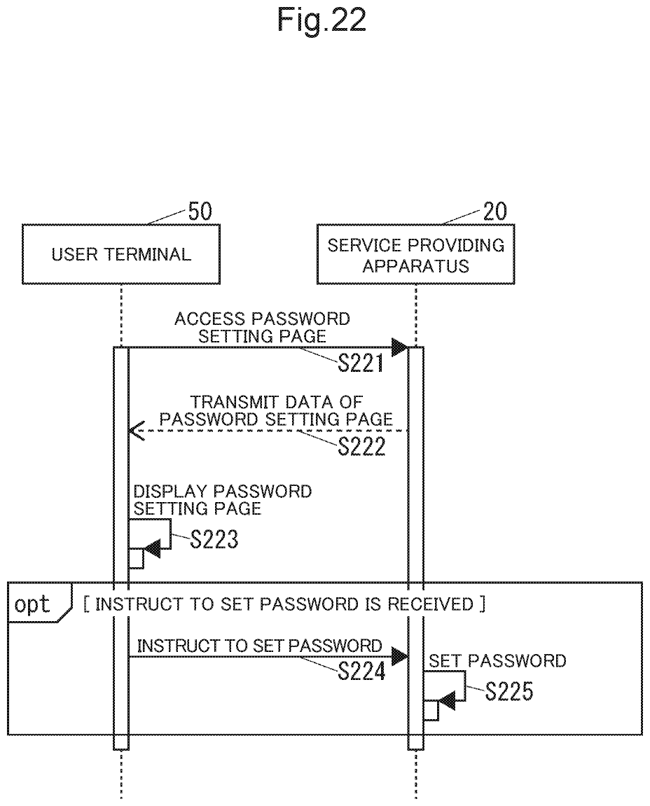

FIG. 22 is a flowchart of an operation of the system 10 in a case where the user who receives the password setting mail at the user terminal 50 sets the password.

The user can instruct the web browser 55a of the user terminal 50 to access a password setting page by receiving the password setting mail at the electronic mail client 55b of the user terminal 50 and clicking the link included in the password setting mail. When the access to the password setting page is instructed, the web browser 55a accesses the password setting page as shown in FIG. 22 (S221).

When the password setting page is accessed in S221, the service provider 25a of the service providing apparatus 20 transmits data of the password setting page to the web browser 55a of the user terminal 50 (S222).

When the data of the password setting page transmitted in S222 is received, the web browser 55a displays the password setting page on the display device 42 on the basis of the received data (S223). In the password setting page, a password desired by the user can be input. In the password setting page, an instruction to set a password can be received in a state in which the password is input.

When the instruction to set a password is received in the password setting page, the web browser 55a instructs the service providing apparatus 20 to set the password input in the password setting page at a point of time at which the instruction to set a password is received (S224).

When the instruction is received in S224, the service provider 25a of the service providing apparatus 20 sets the password instructed in S224 as the password in the user management information 24d associated with the user name that is associated with the password setting page (S225).

As described above, because the service providing apparatus 20 changes an external user corresponding to account information deleted from a user management system to a local user (S208), it is possible to provide a service to a user deleted from an external user management system.

Because the service providing apparatus 20 changes an external user corresponding to account information deleted from a user management system to a local user (S208) in a case where authentication of the external user corresponding to the account information deleted from the user management system is executed in the service providing apparatus itself by a method different from a method by the user management system (S203), it is possible to improve convenience.

Because the service providing apparatus 20 deletes an external user corresponding to account information deleted from a user management system after a specific period (S183), it is possible to reduce a possibility of storing an external user having low necessity for changing to a local user for a long period.

Because the service providing apparatus 20 transmits an electronic mail for setting a password of a local user in the case of changing an external user to a local user (S210), it is possible to improve convenience.

### Second Embodiment

First, a configuration of a system according to a second embodiment of the present disclosure will be described.

The configuration of the system according to the present embodiment is similar to the configuration of the system according to the first embodiment excluding matters described below. Accordingly, components similar to the components of the system according to the first embodiment among components of the system according to the present embodiment are represented by the same reference numbers as the components of the system according to the first embodiment, and detailed description will not be repeated.

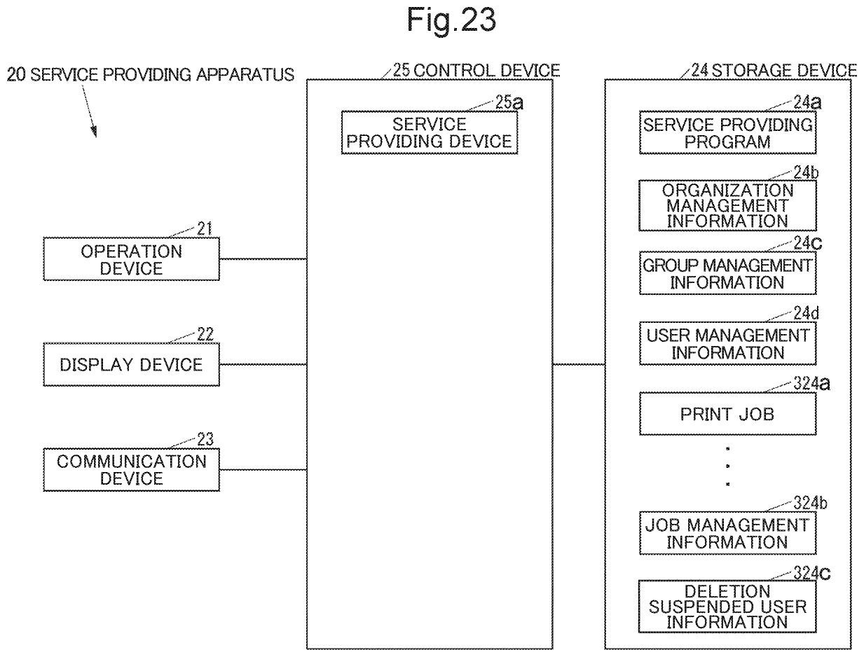

FIG. 23 is a block diagram of an example of a service providing apparatus 20 according to the present embodiment in the case of being configured with one computer.

As shown in FIG. 23, a storage device 24 of the service providing apparatus 20 according to the present embodiment stores a plurality of print jobs that are executed by an image forming apparatus. For example, the storage device 24 stores a print job 324a.

The storage device 24 of the service providing apparatus 20 according to the present embodiment stores job management information 324b for managing a print job stored in the storage device 24.

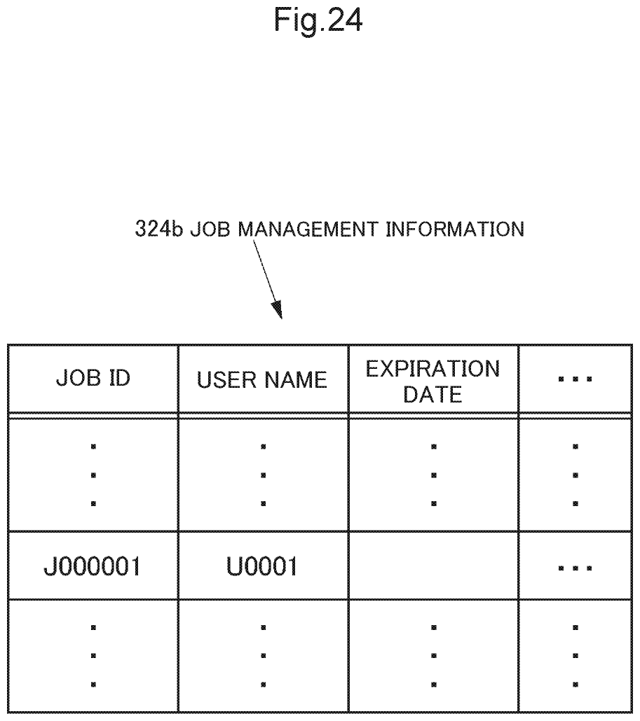

FIG. 24 is a diagram showing an example of the job management information 324b. The job management information 324b shown in FIG. 24 includes a job ID as identification information of a print job, a user name of a user as a target of a print job, and an expiration date of a print job, for each print job. In the job management information 324b shown in FIG. 24, some pieces of information are omitted. A user name of a user as a target of a print job and an expiration date of a print job may be designated, for example, when a print job is transmitted to the service providing apparatus 20.

As shown in FIG. 23, the storage device 24 can store deletion suspended user information 324c indicating a user of which deletion from the user management information 24d is suspended, instead of the deletion suspended user information 24e (see FIG. 23). The deletion suspended user information 324c includes a user name of a user of which deletion from the user management information 24d is suspended, but does not include scheduled deletion date and time from the user management information 24d.

Next, an operation of the system 10 according to the present embodiment will be described. The operation of the system 10 according to the present embodiment is similar to the operation of the system 10 according to the first embodiment excluding operations described below.

First, an operation of the service providing apparatus 20 in the case of storing a print job in the storage device 24 will be described.

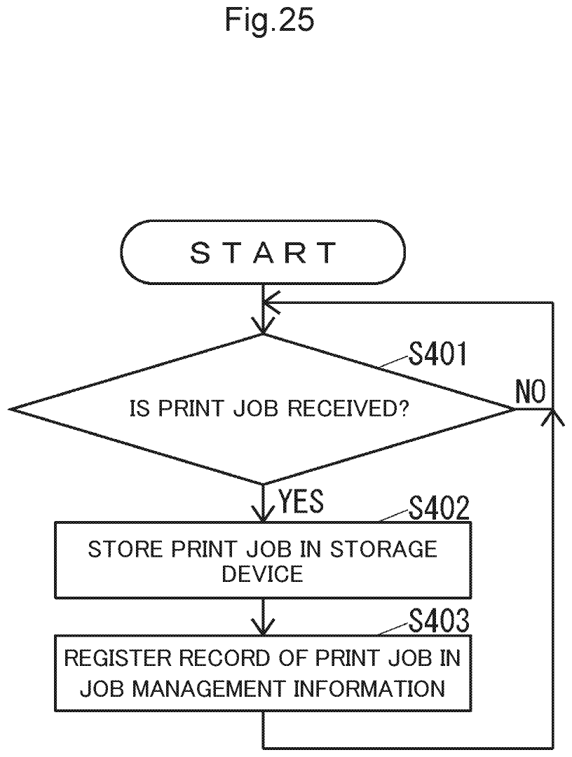

FIG. 25 is a flowchart of an operation of the service providing apparatus 20 in the case of storing a print job in the storage device 24.

The user can transmit a print job to the service providing apparatus 20 from the user terminal 50 in the case of having logged into the service providing apparatus 20 via the web browser 55a of the user terminal 50, for example. The user can set the expiration date of the print job in the case of transmitting the print job to the service providing apparatus 20 from the user terminal 50.

As shown in FIG. 25, the service provider 25a of the service providing apparatus 20 determines whether the print job is received via the communication device 23 until determination is made that the print job is received via the communication device 23 (S401).

When determination is made in S401 that the print job is received via the communication device 23, the service provider 25a stores the received print job in the storage device 24 (S402).

When the processing of S402 ends, the service provider 25a registers a record of the print job stored in the storage device 24 in S402 in the job management information 324b (S403). That is, the service provider 25a stores the job ID of the print job stored in the storage device 24 in S402, the expiration date set for the print job, and the user name of the user who transmits the print job, in the job management information 324b in association with one another.

When the processing of S403 ends, the service provider 25a executes the processing of S401.

Next, an operation of the service providing apparatus 20 in the case of synchronizing a user who is managed by the user management system 30, with the service providing apparatus 20 in the second embodiment will be described.

The manager instructs the service providing apparatus 20 to synchronize a user of a specific user management system via the web browser 45a in the case of having logged into the service providing apparatus 20 via the web browser 45a of the manager terminal 40.

Hereinafter, a case where the service providing apparatus 20 is instructed to synchronize a user who is managed by the user management system 30, with the service providing apparatus 20 will be described as an example.

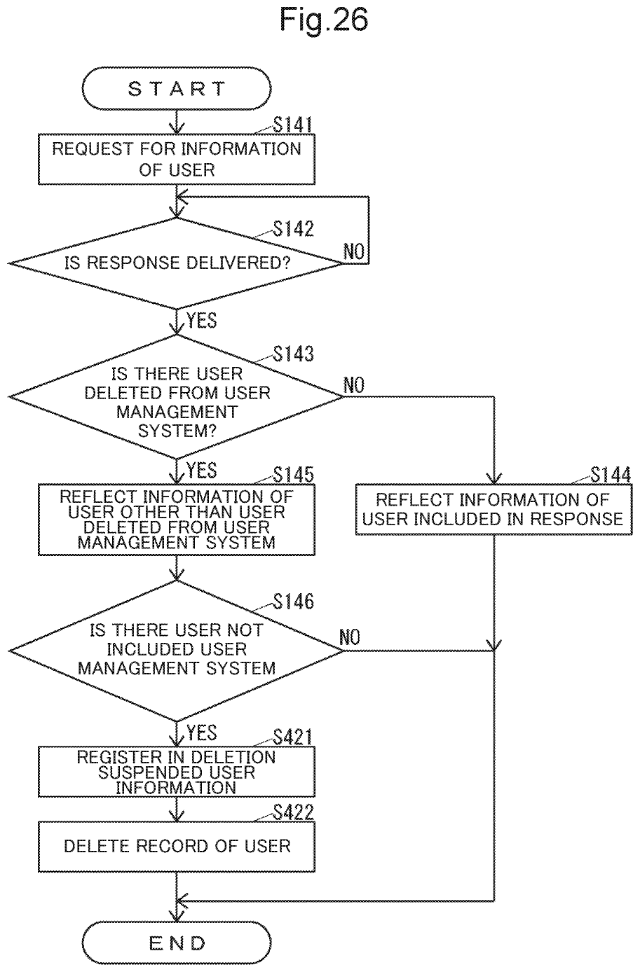

FIG. 26 is a flowchart of an operation of the service providing apparatus 20 in a case where synchronization of a user of the user management system 30 is instructed.

When the synchronization of a user of the user management system 30 is instructed, the service provider 25a of the service providing apparatus 20 executes the operation shown in FIG. 26, not the operation shown in FIG. 18.

As shown in FIG. 26, the service provider 25a executes the processing of S141 to S146 similarly to the operation shown in FIG. 18.

When determination is made in S146 that there is a user not included in the deletion suspended user information 24e among the users in the user management information 24d deleted from the user management system 30, the service provider 25a registers, in the deletion suspended user information 24e, a user name of a user who is not included in the deletion suspended user information 24e and has a print job associated with himself/herself stored in the storage device 24, among the users in the user management information 24d deleted from the user management system 30 (S421).

When the processing of S421 ends, the service provider 25a deletes, from the user management information 24d, a record of a user who is not included in the deletion suspended user information 24e and has a print job associated with himself/herself not stored in the storage device 24, among the users in the user management information 24d deleted from the user management system 30 (S422).

When the processing of S144 is executed, when determination is made in S146 that there is no user not included in the deletion suspended user information 24e among the users in the user management information 24d deleted from the user management system 30, or when the processing of S422 is executed, the service provider 25a ends the operation shown in FIG. 26.

Next, an operation of the service providing apparatus 20 in the case of automatically executing synchronization of a user of a user management system will be described.

Hereinafter, an operation of the service providing apparatus 20 in the case of automatically executing synchronization of a user who is managed by the user management system 30, with the service providing apparatus 20 will be described as an example.

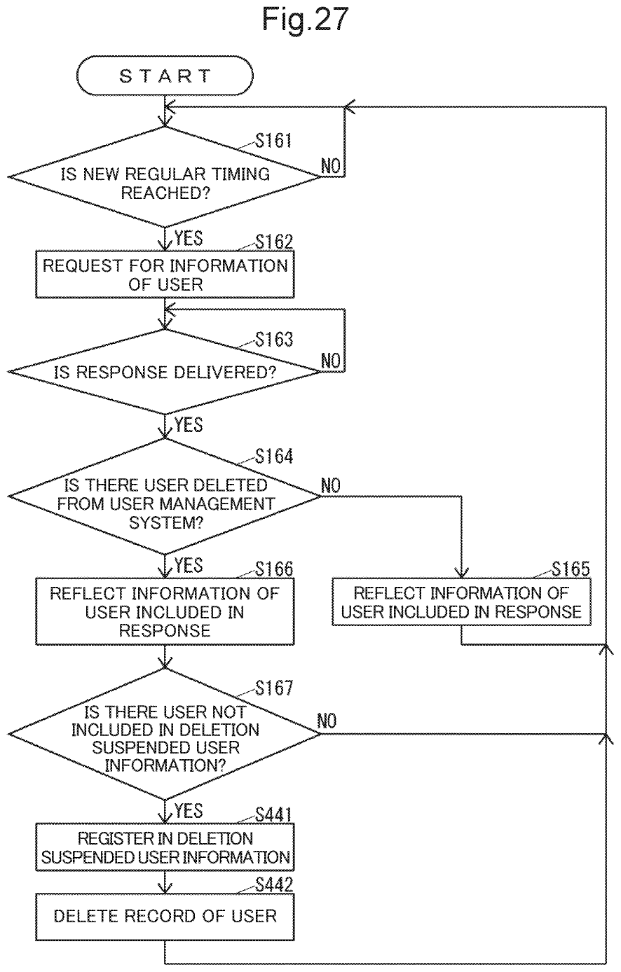

FIG. 27 is a flowchart of an operation of the service providing apparatus 20 in the case of automatically executing synchronization of a user who is managed by the user management system 30, with the service providing apparatus 20.

In a case where the synchronization timing of the user management system 30 in the organization management information 24b is set for the organization in the service providing apparatus 20, the service provider 25a of the service providing apparatus 20 executes the operation shown in FIG. 27 on the organization, not the operation shown in FIG. 19.

As shown in FIG. 27, the service provider 25a executes the processing of S161 to S167 similarly to the operation shown in FIG. 19.

When determination is made in S167 that there is a user not included in the deletion suspended user information 24e among the users in the user management information 24d deleted from the user management system 30, the service provider 25a registers, in the deletion suspended user information 24e, a user name of a user who is not included in the deletion suspended user information 24e and has a print job associated with himself/herself stored in the storage device 24, among the users in the user management information 24d deleted from the user management system 30 (S441).

When the processing of S441 ends, the service provider 25a deletes, from the user management information 24d, a record of a user who is not included in the deletion suspended user information 24e and has a print job associated with himself/herself stored in the storage device 24, among the users in the user management information 24d deleted from the user management system 30 (S442).

When the processing of S165 is executed, when determination is made in S167 that there is no user not included in the deletion suspended user information 24e among the users in the user management information 24d deleted from the user management system 30, or when the processing of S442 is executed, the service provider 25a executes the processing of S161.

Next, an operation of the service providing apparatus 20 in the case of deleting a print job from the storage device 24 will be described.

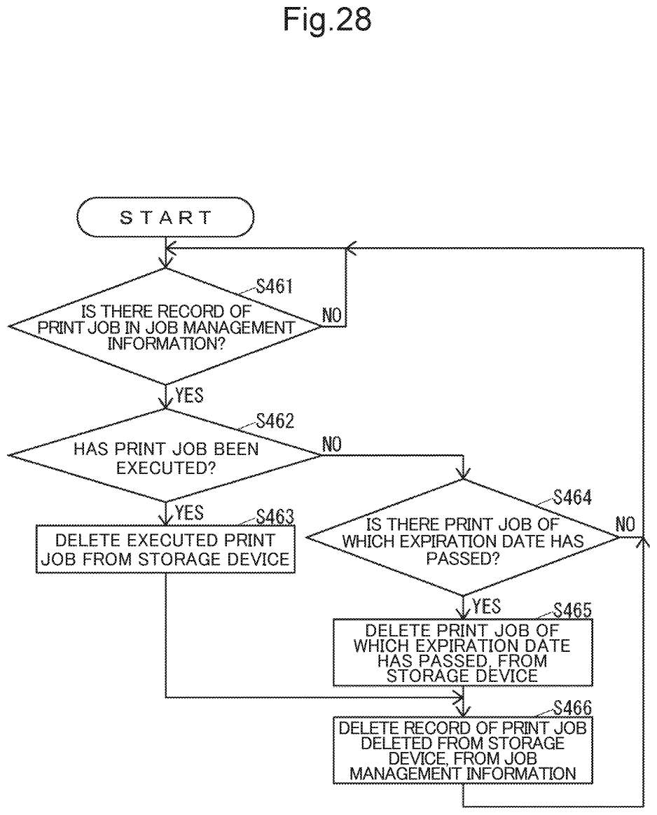

FIG. 28 is a flowchart of an operation of the service providing apparatus 20 in the case of deleting a print job from the storage device 24.

As shown in FIG. 28, the service provider 25a of the service providing apparatus 20 determines whether there is a record of a print job in the job management information 324b until determination is made that there is a record of a print job in the job management information 324b (S461).

When determination is made in S461 that there is a record of a print job in the job management information 324b, the service provider 25a determines whether the print job stored in the storage device 24 has been executed by the image forming apparatus (S462).

When determination is made in S462 that the print job stored in the storage device 24 has been executed by the image forming apparatus, the service provider 25a deletes the print job executed by the image forming apparatus from the storage device 24 (S463).

When determination is made in S462 that the print job stored in the storage device 24 is not executed by the image forming apparatus, the service provider 25a determines whether there is a print job of which the expiration date has passed, on the basis of the job management information 324b (S464).

When determination is made in S464 that there is a print job of which the expiration date has passed, the service provider 25a deletes the print job of which the expiration date has passed, from the storage device 24 (S465).

When the processing of S463 or S465 ends, the service provider 25a deletes the record of the print job deleted in S463 or S465 from the job management information 324b (S466).

When determination is made in S464 that there is no print job of which the expiration date has passed or when the processing of S466 ends, the service provider 25a executes the processing of S461.

Next, an operation of the service providing apparatus 20 in the case of deleting information of a user included in the deletion suspended user information 324c from the user management information 24d will be described.

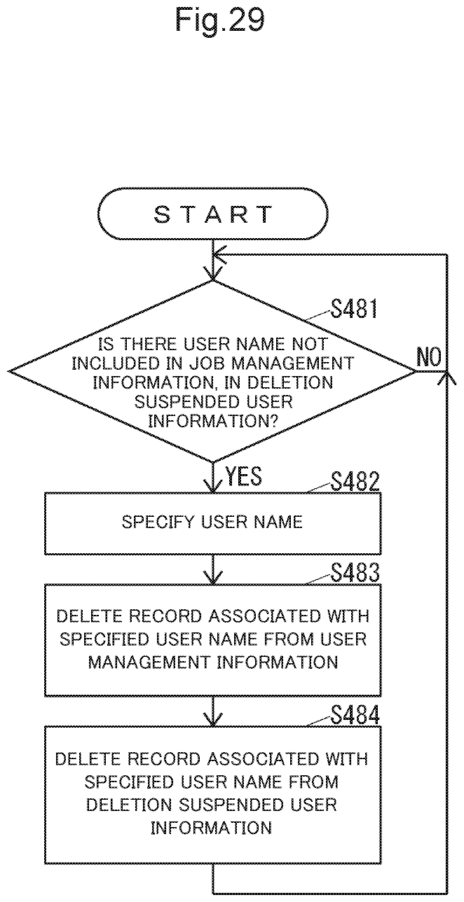

FIG. 29 is a flowchart of an operation of the service providing apparatus 20 in the case of deleting information of a user included in the deletion suspended user information 324c from the user management information 24d.

The service provider 25a of the service providing apparatus 20 executes the operation shown in FIG. 29 in a case where a user is included in the deletion suspended user information 324c.

As shown in FIG. 29, the service provider 25a determines whether a user name not included in the job management information 324b is present in the deletion suspended user information 324c until determination is made that a user name not included in the job management information 324b is present in the deletion suspended user information 324c (S481).

When determination is made in S481 that a user name not included in the job management information 324b is present in the deletion suspended user information 324c, the service provider 25a specifies a user name that is not included in the job management information 324b and is present in the deletion suspended user information 324c (S482).

When the processing of S482 ends, the service provider 25a deletes the record associated with the user name specified in S482 from the user management information 24d (S483).

When the processing of S483 ends, the service provider 25a deletes the record associated with the user name specified in S482 from the deletion suspended user information 324c (S484).

When the processing of S484 ends, the service provider 25a executes the processing of S481.

Because in a case where a print job of an external user corresponding to account information deleted from a user management system is not retained (in S481, YES), the service providing apparatus 20 deletes the external user (S483), it is possible to reduce a possibility of storing an external user having low necessity for changing to a local user for a long period.

### Third Embodiment

First, a configuration of a system according to a third embodiment of the present disclosure will be described.

The configuration of the system according to the present embodiment is similar to the configuration of the system according to the first embodiment excluding matters described below. Accordingly, components similar to the components of the system according to the first embodiment among components of the system according to the present embodiment are represented by the same reference numbers as the components of the system according to the first embodiment, and detailed description will not be repeated.

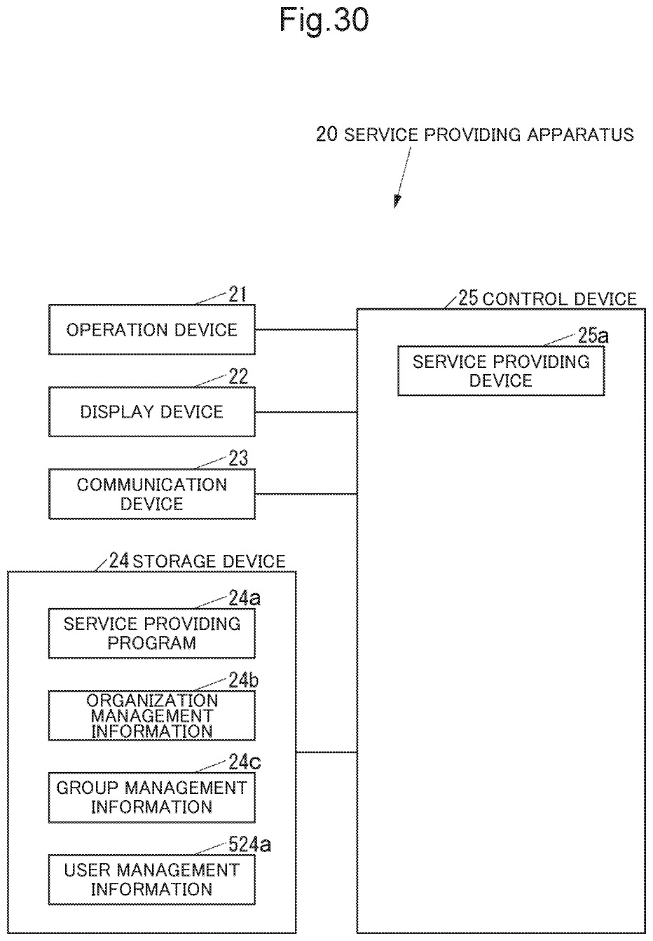

FIG. 30 is a block diagram of an example of a service providing apparatus 20 according to the present embodiment in the case of being configured with one computer.

As shown in FIG. 30, a storage device 24 of the service providing apparatus 20 according to the present embodiment stores user management information 524a for managing a user of the service providing apparatus 20, instead of the user management information 24d (see FIG. 2).

The storage device 24 of the service providing apparatus 20 according to the present embodiment does not store the deletion suspended user information 24e (see FIG. 2).

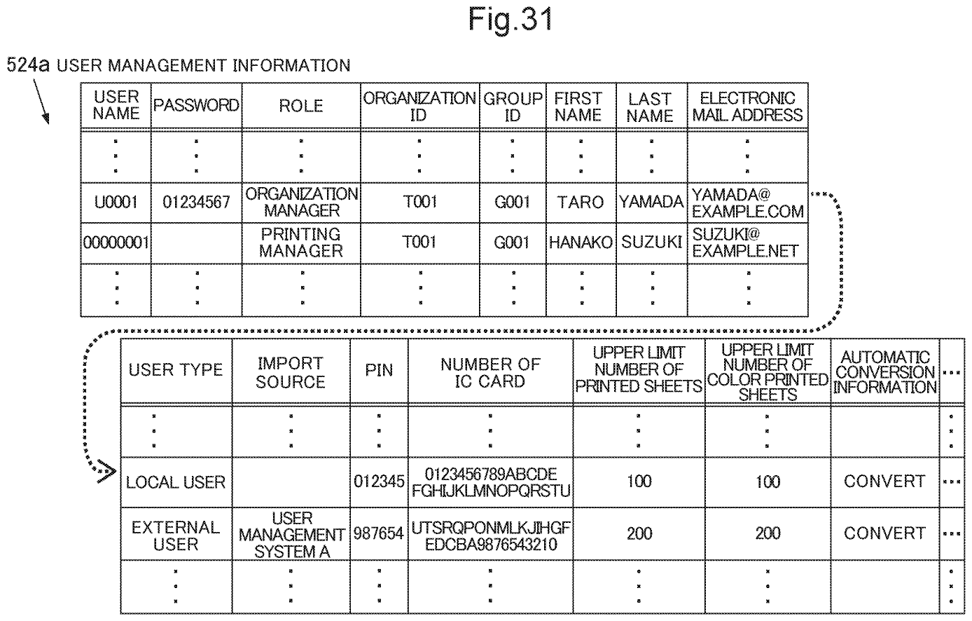

FIG. 31 is a diagram showing an example of the user management information 524a. As shown in FIG. 31, the user management information 524a is similar to the user management information 24d (see FIG. 5), excluding that automatic conversion information indicating whether to convert an external user to a local user in the case of being deleted from a user management system is included, for each user of the service providing apparatus 20.

Next, an operation of the system 10 according to the present embodiment will be described. The operation of the system 10 according to the present embodiment is similar to the operation of the system 10 according to the first embodiment excluding operations described below.

First, an operation of the service providing apparatus 20 in a case where synchronization of a user of a user management system is instructed will be described.

The manager can instruct the service providing apparatus 20 to synchronize a user of a specific user management system via the web browser 45a in the case of having logged into the service providing apparatus 20 via the web browser 45a of the manager terminal 40.

Hereinafter, a case where the manager instructs the service providing apparatus 20 to synchronize a user of the user management system 30 will be described as an example.

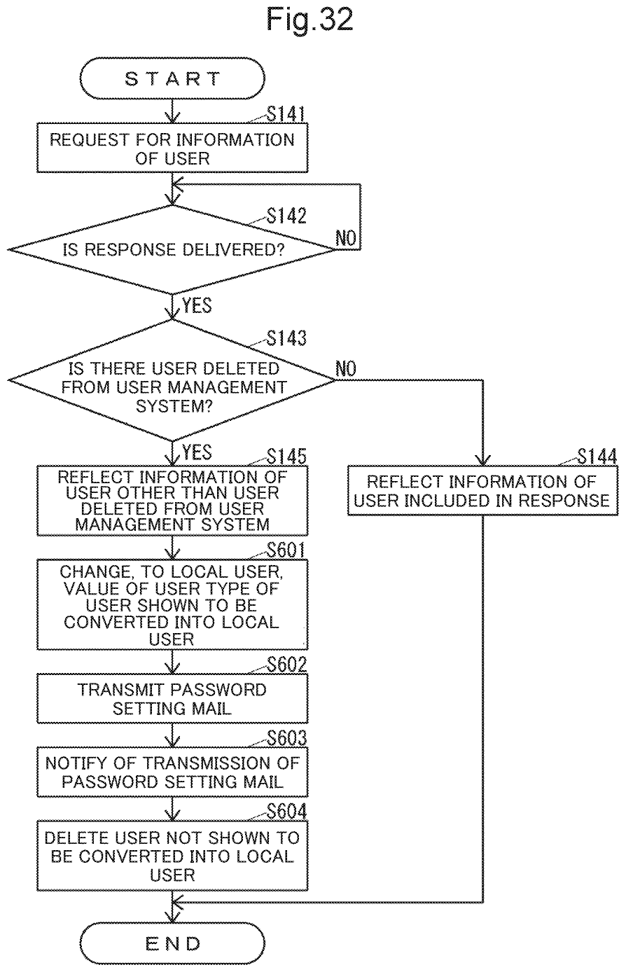

FIG. 32 is a flowchart of an operation of the service providing apparatus 20 in a case where synchronization of a user of the user management system 30 is instructed.

When the synchronization of a user of the user management system 30 is instructed, the service provider 25a of the service providing apparatus 20 executes the operation shown in FIG. 32, not the operation shown in FIG. 18.

As shown in FIG. 32, the service provider 25a executes the processing of S141 to S145 similarly to the operation shown in FIG. 18.

When the processing of S145 ends, the service provider 25a changes, to a local user, a value of a user type in the user management information 24d associated with a user name of a user for which converting an external user into a local user in the case of having been deleted from a user management system is shown in the automatic conversion information of the user management information 524a, among the users in the user management information 24d deleted from the user management system 30 (S601). The service provider 25a deletes the name of the user management system as an import source in the user management information 24d associated with the user name. In a case where “NOT HANDOVER” is shown in the handover information regarding a role in the organization management information 24b that is associated with an organization ID in the user management information 24d associated with the user name, the service provider 25a sets the role in the user management information 24d associated with the user name as a “general user”. In a case where “NOT HANDOVER” is shown in the handover information regarding a group in the organization management information 24b that is associated with the organization ID in the user management information 24d associated with the user name, the service provider 25a sets the group ID in the user management information 24d associated with the user name as a group ID of a group that is shown as the default group in the group management information 24c in association with the organization ID. In a case where “NOT HANDOVER” is shown in the handover information regarding a printing setting in the organization management information 24b that is associated with the organization ID in the user management information 24d associated with the user name, the service provider 25a deletes the values of the upper limit number of printed sheets and the upper limit number of color printed sheets in the user management information 24d associated with the user name.

When the processing of S601 ends, the service provider 25a transmits a password setting mail to an electronic mail address in the user management information 24d associated with the user name as a target to be processed in S601 (S602). The password setting mail includes a link of a password setting page that is a web page for setting a password of a user. The password setting page is associated with the user name as a target to be processed in S601.

When the processing of S602 ends, the service provider 25a notifies the web browser 45a of the manager terminal 40 that the password setting mail is transmitted (S603). The service provider 25a may include the electronic mail address of the transmission destination of the password setting mail in the notification in S603. When the notification is received in S603, the web browser 45a of the manager terminal 40 displays information indicating that the password setting mail is transmitted, on the display device 42 of the manager terminal 40. The web browser 45a may include the electronic mail address of the transmission destination of the password setting mail in the display of information indicating that the password setting mail is transmitted.

When the processing of S603 ends, the service provider 25a deletes, from the user management information 24d, a record of a user for which not converting an external user into a local user in the case of having been deleted from the user management system is shown in the automatic conversion information of the user management information 524a, among the users in the user management information 24d deleted from the user management system 30 (S604).

When the processing of S144 or S604 ends, the service provider 25a ends the operation of FIG. 32.

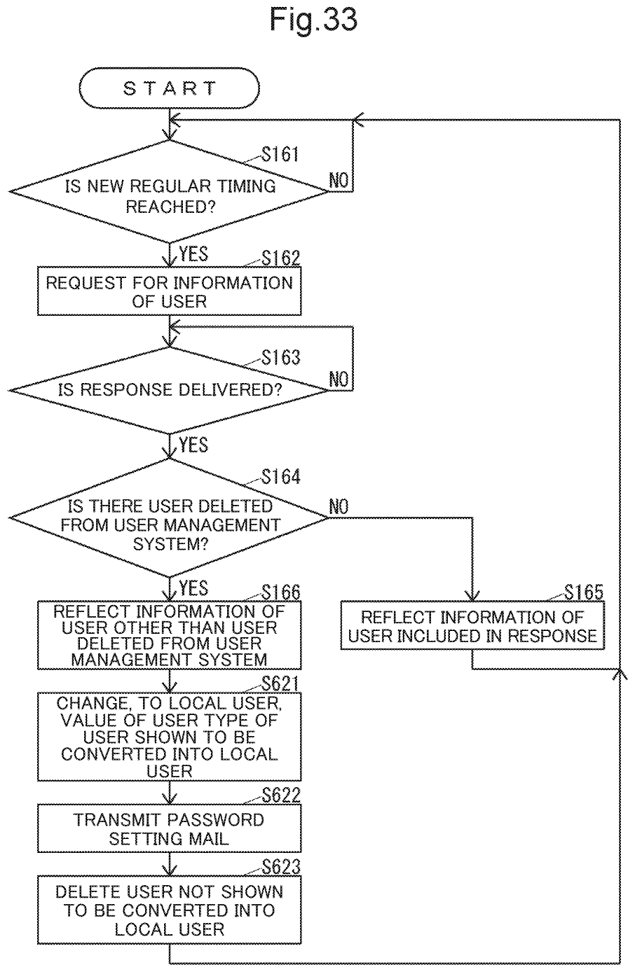

Next, an operation of the service providing apparatus 20 in the case of automatically executing synchronization of a user of a user management system will be described. FIG. 33 is a flowchart of an operation of the service providing apparatus 20 in the case of automatically executing synchronization of a user of the user management system 30.

In a case where the synchronization timing of the user management system 30 in the organization management information 24b is set on an organization in the service providing apparatus 20, the service provider 25a of the service providing apparatus 20 executes the operation shown in FIG. 33 on the organization, not the operation shown in FIG. 19.

As shown in FIG. 33, the service provider 25a executes the processing of S161 to S166 similarly to the operation shown in FIG. 19.

When the processing of S166 ends, the service provider 25a changes, to a local user, a value of a user type in the user management information 24d associated with a user name of a user for which converting an external user into a local user in the case of having been deleted from a user management system is shown in the automatic conversion information of the user management information 524a, among the users in the user management information 24d deleted from the user management system 30 (S621). The service provider 25a deletes the name of the user management system as an import source in the user management information 24d associated with the user name. In a case where “NOT HANDOVER” is shown in the handover information regarding a role in the organization management information 24b that is associated with an organization ID in the user management information 24d associated with the user name, the service provider 25a sets the role in the user management information 24d associated with the user name as a “general user”. In a case where “NOT HANDOVER” is shown in the handover information regarding a group in the organization management information 24b that is associated with the organization ID in the user management information 24d associated with the user name, the service provider 25a sets the group ID in the user management information 24d associated with the user name as a group ID of a group that is shown as the default group in the group management information 24c in association with the organization ID. In a case where “NOT HANDOVER” is shown in the handover information regarding a printing setting in the organization management information 24b that is associated with the organization ID in the user management information 24d associated with the user name, the service provider 25a deletes the values of the upper limit number of printed sheets and the upper limit number of color printed sheets in the user management information 24d associated with the user name.

When the processing of S621 ends, the service provider 25a transmits a password setting mail to an electronic mail address in the user management information 24d associated with the user name as a target to be processed in S621 (S622). The password setting mail includes a link of a password setting page that is a web page for setting a password of a user. The password setting page is associated with the user name as a target to be processed in S621.

When the processing of S622 ends, the service provider 25a deletes, from the user management information 24d, a record of a user for which not converting an external user into a local user in the case of having been deleted from the user management system is shown in the automatic conversion information of the user management information 524a, among the users in the user management information 24d deleted from the user management system 30 (S623).

When the processing of S165 or S623 ends, the service provider 25a executes the processing of S161.

As described above, because the service providing apparatus 20 changes an external user corresponding to account information deleted from a user management system to a local user (S601 or S621), it is possible to provide a service to a user deleted from an external user management system.

Because the service providing apparatus 20 changes an external user to a local user in a case where account information corresponding to an external user for which changing an external user corresponding to account information deleted from a user management system to a local user is set in advance, is deleted from the user management system (S601 or S621), it is possible to improve convenience.

Because the service providing apparatus 20 transmits an electronic mail for setting a password of a local user in the case of changing an external user to a local user (S602 or S622), it is possible to improve convenience.

### Fourth Embodiment

First, a configuration of a system according to a fourth embodiment of the present disclosure will be described.

The configuration of the system according to the present embodiment is similar to the configuration of the system according to the first embodiment excluding matters described below. Accordingly, components similar to the components of the system according to the first embodiment among components of the system according to the present embodiment are represented by the same reference numbers as the components of the system according to the first embodiment, and detailed description will not be repeated.

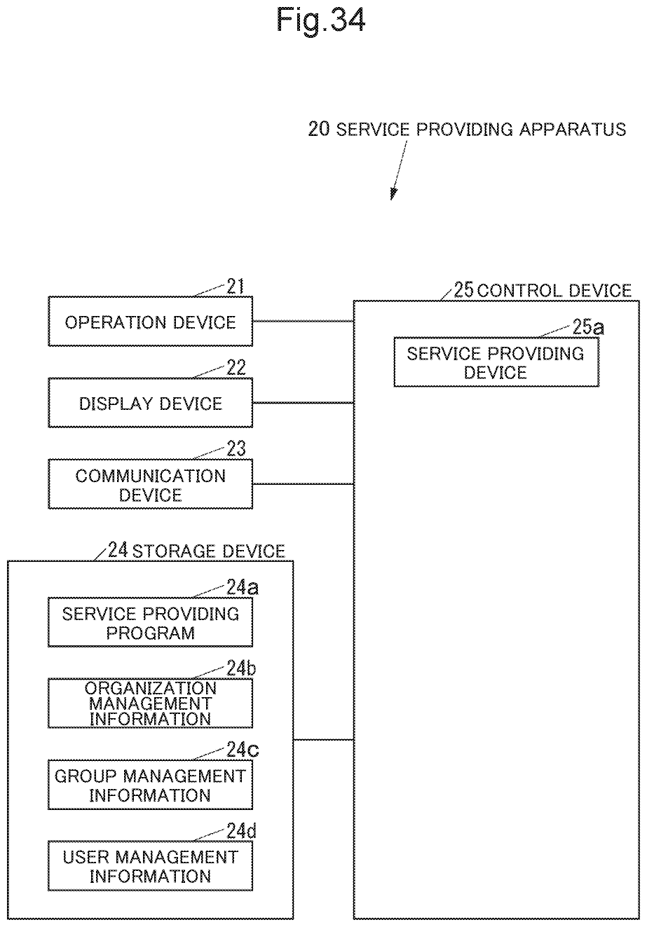

FIG. 34 is a block diagram of an example of a service providing apparatus 20 according to the present embodiment in the case of being configured with one computer. As shown in FIG. 34, a storage device 24 of the service providing apparatus 20 according to the present embodiment does not store the deletion suspended user information 24e (see FIG. 2).

Next, an operation of the system 10 according to the present embodiment will be described. The operation of the system 10 according to the present embodiment is similar to the operation of the system 10 according to the first embodiment excluding operations described below.

First, an operation of the service providing apparatus 20 in the case of automatically executing synchronization of a user of a user management system will be described.

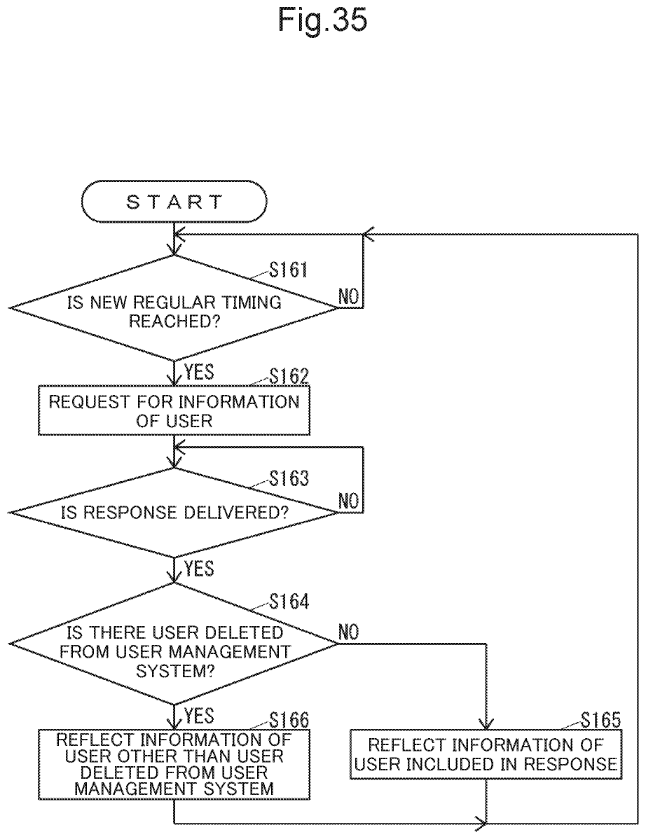

Hereinafter, an operation of the service providing apparatus 20 in the case of automatically executing synchronization of a user of the user management system 30 will be described as an example. FIG. 35 is a flowchart of an operation of the service providing apparatus 20 in the case of automatically executing synchronization of a user of the user management system 30.

In a case where the synchronization timing of the user management system 30 in the organization management information 24b is set for the organization in the service providing apparatus 20, the service provider 25a of the service providing apparatus 20 executes the operation shown in FIG. 35 on the organization, not the operation shown in FIG. 19.

As shown in FIG. 35, the service provider 25a executes the processing of S161 to S166 similarly to the operation shown in FIG. 19.

When the processing of S165 or S166 ends, the service provider 25a executes the processing of S161.

Next, an operation of the service providing apparatus 20 in a case where synchronization of a user of a user management system is instructed will be described.

The manager can instruct the service providing apparatus 20 to synchronize a user of a specific user management system via the web browser 45a in the case of having logged into the service providing apparatus 20 via the web browser 45a of the manager terminal 40.

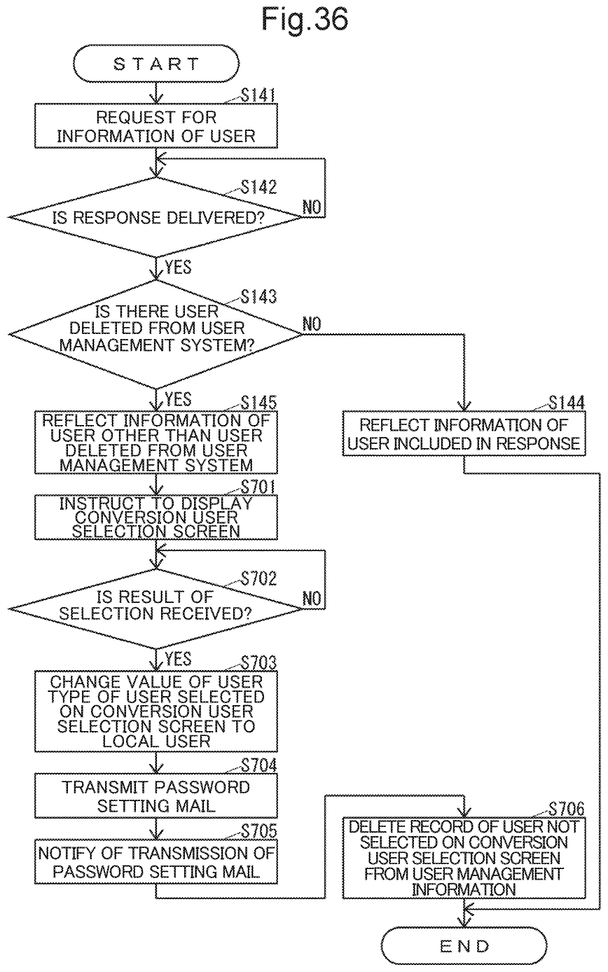

Hereinafter, a case where the manager instructs the service providing apparatus 20 to synchronize a user of the user management system 30 will be described as an example. FIG. 36 is a flowchart of an operation of the service providing apparatus 20 in a case where synchronization of a user of the user management system 30 is instructed.

When the synchronization of a user of the user management system 30 is instructed, the service provider 25a of the service providing apparatus 20 executes the operation shown in FIG. 36, not the operation shown in FIG. 18.

As shown in FIG. 36, the service provider 25a executes the processing of S141 to S145 similarly to the operation shown in FIG. 18.

When the processing of S145 ends, the service provider 25a instructs the web browser 45a of the manager terminal 40 to display a screen (hereinafter, referred to as a “conversion user selection screen”) for selecting a user to be converted into a local user among the users in the user management information 24d deleted from the user management system 30 (S701). When the instruction is received in S701, the web browser 45a of the manager terminal 40 displays the conversion user selection screen on the display device 42 of the manager terminal 40 according to the instruction in S701. On the conversion user selection screen, a user to be converted into a local user can be selected. When a user to be converted into a local user is selected on the conversion user selection screen, the web browser 45a notifies the service providing apparatus 20 of a result of selection on the conversion user selection screen.

When the processing of S701 ends, the service provider 25a of the service providing apparatus 20 determines whether the result of the selection on the conversion user selection screen is received from the web browser 45a of the manager terminal 40 until determination is made that the result of selection on the conversion user selection screen is received from the web browser 45a of the manager terminal 40 (S702).

When determination is made in S702 that the result of selection on the conversion user selection screen is received from the web browser 45a of the manager terminal 40, the service provider 25a changes, to a local user, a value of a user type in the user management information 24d associated with a user name of a user selected on the conversion user selection screen among the users in the user management information 24d deleted from the user management system 30 (S703). The service provider 25a deletes the name of the user management system as an import source in the user management information 24d associated with the user name. In a case where “NOT HANDOVER” is shown in the handover information regarding a role in the organization management information 24b that is associated with an organization ID in the user management information 24d associated with the user name, the service provider 25a sets the role in the user management information 24d associated with the user name as a “general user”. In a case where “NOT HANDOVER” is shown in the handover information regarding a group in the organization management information 24b that is associated with the organization ID in the user management information 24d associated with the user name, the service provider 25a sets the group ID in the user management information 24d associated with the user name as a group ID of a group that is shown as the default group in the group management information 24c in association with the organization ID. In a case where “NOT HANDOVER” is shown in the handover information regarding a printing setting in the organization management information 24b that is associated with the organization ID in the user management information 24d associated with the user name, the service provider 25a deletes the values of the upper limit number of printed sheets and the upper limit number of color printed sheets in the user management information 24d associated with the user name.

When the processing of S703 ends, the service provider 25a transmits a password setting mail to an electronic mail address in the user management information 24d associated with the user name as a target to be processed in S703 (S704). The password setting mail includes a link of a password setting page that is a web page for setting a password of a user. The password setting page is associated with the user name as a target to be processed in S703.

When the processing of S704 ends, the service provider 25a notifies the web browser 45a of the manager terminal 40 that the password setting mail is transmitted (S705). The service provider 25a may include the electronic mail address of the transmission destination of the password setting mail in the notification in S705. When the notification is received in S705, the web browser 45a of the manager terminal 40 displays information indicating that the password setting mail is transmitted, on the display device 42 of the manager terminal 40. The web browser 45a may include the electronic mail address of the transmission destination of the password setting mail in the display of information indicating that the password setting mail is transmitted.

When the processing of S705 ends, the service provider 25a deletes, from the user management information 24d, a record of a user not selected on the conversion user selection screen among the users in the user management information 24d deleted from the user management system 30 (S706).

When the processing of S706 ends, the service provider 25a ends the operation of FIG. 36.

As described above, because the service providing apparatus 20 changes an external user corresponding to account information deleted from a user management system to a local user (S703), it is possible to provide a service to a user deleted from an external user management system.

Because the service providing apparatus 20 generates a list of external users corresponding to account information deleted from a user management system (S701), and changes an external user selected from the list to a local user (S703) in a case where synchronization of a user of a user management system and an external user is instructed, it is possible to improve convenience.

Because the service providing apparatus 20 transmits an electronic mail for setting a password of a local user in the case of changing an external user to a local user (S704), it is possible to improve convenience.

That is, in the technique not based on the above-described embodiments, there is a problem in that a user deleted from one system cannot leave in another system; however, according to each embodiment described above, it is possible to provide a handover service to a user deleted from an external user management system.

While the present disclosure has been described in detail with reference to the embodiments thereof, it would be apparent to those skilled in the art that the various changes and modifications may be made therein within the scope defined by the appended claims.

What is claimed is;

1. A service providing apparatus that provides a specific service to a user, the service providing apparatus comprising:
a storage device configured to store a service providing program; and
a control device including a processor that, upon execution of the service providing program by the processor,
functions as a service provider configured to perform a process in cases including:
(i) managing a local user on the basis of authentication by the service providing apparatus itself;
(ii) accepting an import of an external user from a user management system that is connected to the service providing apparatus and independently manages a user as an external user; and
(iii) receiving account information indicating the external user to be imported from the user management system during the import, wherein, when an external user that is managed in the service providing apparatus is indicated as deleted in the account information, the service provider changes the deleted external user to a local user and manages the changed local user in the service providing apparatus.

2. The service providing apparatus according to claim 1,
wherein the service provider is configured to change, in a case where authentication of the external user corresponding to the account information deleted from the user management system is executed by the service providing apparatus itself separately from a method by the user management system, the external user corresponding to the account information deleted from the user management system to the local user.

3. The service providing apparatus according to claim 1,
wherein the service provider is configured to delete the external user corresponding to the account information deleted from the user management system after a specific period.

4. The service providing apparatus according to claim 1,
wherein the service provider is configured to delete, in a case where a job associated with an external user deleted in the account information received from the user management system is not retained, the external user from a target to be managed in the service providing apparatus.

5. The service providing apparatus according to claim 1,
wherein the service provider is configured to change, in a case where a job associated with an external user deleted in the account information received from the user management system is retained, the external user to the local user.

6. The service providing apparatus according to claim 1,
wherein the service provider is configured to change, in a case where an external user deleted by the account information received from the user management system is set in advance as a user who permits change to a local user, the deleted external user to the local user.

7. The service providing apparatus according to claim 1,
wherein the service provider is configured to change, when account information indicating the external user to be imported is received from the user management system during the import, in a case where an external user that is managed in the service providing apparatus is deleted in the account information, only the selected external user among the deleted external users to the local user.

8. The service providing apparatus according to claim 1,
wherein the service provider is configured to transmit, in a case of changing the external user to the local user, an electronic mail for setting a password of the local user to a user indicated by the external user or a manager.

9. A computer-readable non-transitory recording medium storing a service providing program causing a computer to operate as a service provider configured to perform a process in cases including:
(i) managing a local user on the basis of authentication by the service providing apparatus itself;
(ii) accepting an import of an external user from a user management system that is connected to the service providing apparatus and independently manages a user as an external user; and
(iii) receiving account information indicating the external user to be imported from the user management system during the import, wherein, when an external user that is managed in the service providing apparatus is indicated as deleted in the account information, the service provider changes the deleted external user to a local user and manages the changed local user in the service providing apparatus.
